(19) United States
(12) Patent Application Publication
(10) Pub. No.: US 2004/0258229 A1
(43) Pub. Date: Dec. 23, 2004

(54) System and method for managing telephony network resources

(75) Inventor: Yuval Mayron, Netanya (IL)

Correspondence Address: FOLEY AND LARDNER, SUITE 500, 3000 K STREET NW, WASHINGTON, DC, 20007, US

(73) Assignee: Sigvalue Tech. Ltd.

(21) Appl. No.: 10/733,759

(22) Filed: Dec. 12, 2003

Related U.S. Application Data
(63) Continuation-in-part of application No. 09/655,930, filed on Sep. 6, 2000, now Pat. No. 6,738,472.

(51) Int. Cl. H04M 15/00; H04M 11/00

(52) U.S. Cl. 379/114.2; 455/406

(57) ABSTRACT

Network architecture for enabling a first network terminal connected in a call with a second network terminal via a first circuit, to purchase calling time during the call, the network architecture including a first network node connected to the first network terminal, a second network node connected to the second network terminal, an account management node connected to the first network node, and a call management node connected to the first network node, the account management node managing a pre-paid account associated with the first network terminal, the call management node being connected to the first network node via a signaling link, to the account management node via a communication link, and to the second network node, the call management node connecting the first network terminal with the account management node over a second circuit, while the second network terminal is on hold, whereby the first network terminal purchases calling time, the call management node disconnecting the first network terminal from the account management node, when the call-credit of the pre-paid account is positive, thereby allowing the first network terminal to resume the call.

### FIELD OF THE DISCLOSED TECHNIQUE

The disclosed technique relates to telephony communication in general, and to methods and systems for establishing and controlling telephone calls, in particular.

### BACKGROUND OF THE DISCLOSED TECHNIQUE

Reference is now made to FIG. 1, which is a schematic illustration of a system for placing a call between a pre-paid mobile subscriber, and a land subscriber, which is known in the art. The system includes a mobile switching center (MSC) 4, a central office (CO) 10 and a pre-paid system (PPS) 14. Pre-paid system 14 is also known as adjunct switch or service node. Mobile switching center (MSC) 4 is a gateway for a plurality of mobile subscribers (such as mobile subscriber 2) to a wide area telephony network. Central office (CO) 10 is a gateway for a plurality of land subscribers (such as land subscriber 8) to that wide area telephony network. Pre-paid system (PPS) 14 is operative to authorize and control telephony calls from mobile subscriber 2 to another subscriber such as a land subscriber 8 or other mobile subscribers. Mobile switching center (MSC) 4 is coupled to central office (CO) 10 and to pre-paid system (PPS) 14 via respective signaling links 36 and 34. It is noted that signaling links 34 and 36 are typically routed between the various network nodes by signal transfer point (STP) units (not shown), which serve as routers.

In the terminology of conventional telephony, a voice link between network nodes such as links 16, 22 and 28, represents a time slot in a multiplexed voice trunk. Each of the time slots is identified by a circuit identification code (CIC).

When mobile subscriber 2 initiates a telephone call to land subscriber 8, he first establishes a link 6 to MSC 4. It is noted that the type of link between a terminal and a respective network node, is typically different than a link between two network nodes.

MSC 4 initiates a call to PPS 14 via signaling link 34 and further directs the call thereto, via voice link 16, between ports 18 and 20. PPS 14 authorizes that call according to the account status of the mobile subscriber 2 and initiates a call back to MSC 4 via signaling link 34 and further directs that call thereto via voice link 22, between ports 24 and 26. MSC 4 initiates a call to central office (CO) 10 via signaling link 36 and further directs the call received at port 26 to central office (CO) 10, via link 28, between ports 30 and 32. Central office (CO) 10 further directs the call to land subscriber 8 via a link 12.

PPS 14 constantly monitors the call established between mobile subscriber 2 and land subscriber 8, as the call passes there through. It is noted that establishing such a telephone call requires allocating three ports in the MSC 4, two ports in the PPS 14 and one port in the CO 10. Each voice connection port 18, 26 and 30 employs a different circuit identification code and hence, MSC 4 has to assign three CICs for establishing that telephone call.

It will be appreciated by those skilled in the art that for the purpose of establishing a pre-paid call, MSC 4 has to initiate two calls, one from port 18 and another from port 30. The initiation and management of these calls, significantly load the processors of MSC 4. In addition, the capacity of MSC 4 is limited to a predetermined number of calls, which can be managed and switched thereby. Hence, every such pre-paid call, requires switch resources which could have been used for two regular calls. This significantly increases the cost of such a pre-paid call in terms of switching resource allocation.

Reference is now made to FIG. 2, which is a schematic illustration of a system for placing a call between a pre-paid mobile subscriber, and a land subscriber, which is known in the art. MSC 44, CO 50, and PPS 54 are analogous to MSC 4 (FIG. 1), CO 10, and PPS 14, respectively. MSC 44 is coupled to CO 50 and to PPS 54 via respective signaling links 40 and 56.

When mobile subscriber 42 initiates a telephone call to land subscriber 48, he first establishes a link 46 to MSC 44. MSC 44 initiates a call to PPS 54 via signaling link 56. PPS 54 authorizes that call according to the account status of the mobile subscriber 42 and initiates a return call, back to MSC 44 via signaling link 56. In that return call, PPS 54 directs MSC 44, to connect ports 60 and 62 via a voice link 64. The establishing of voice link 64 is known in the art as “loop-around”.

In turn, MSC 44 initiates a call to CO 50 via signaling link 40. MSC 44, further directs the call, received at port 62, to CO 50, via voice link 58, between ports 66 and 68. CO 50 further directs the call to land subscriber 48.

PPS 54 constantly monitors the call established between mobile subscriber 42 and land subscriber 48, by communicating at a signaling level with MSC 44. It is noted that establishing such a telephone call requires allocating three ports in MSC 44, and a single port in CO 50.

Each voice connection port 60, 62 and 66 employs a different circuit identification code and hence, MSC 44 has to assign three CICs for establishing that telephone call. It will be appreciated by those skilled in the art that for the purpose of establishing that pre-paid call, MSC 44 has to initiate two calls, one from port 60 and another from port 66, which significantly load the processors thereof.

U.S. Pat. No. 5,708,702 to De Paul et al. entitled “Dynamic STP routing in response to triggering” is directed to a method for submitting queries to a remote database using SCCP/TCAP protocols. The method employs a common channel interoffice signaling (CCIS) network to determine a parameter respective of the called party (e.g., if the called party is busy), prior to construction of a telephone connection. When an originating end office receives a request to connect a caller to a called party, the originating end office sends a message to the terminating end office, via the CCIS network. The terminating end office determines if the called party is busy. If the called party is busy, then the terminating end office informs the originating end office by sending a message via the CCIS network, and the originating end office provides a busy signal to the caller. If the called party is not busy, then the terminating end office informs the originating end office, and a telephone connection is constructed between the caller and the called party.

U.S. Pat. No. 5,920,562, to Christie et al. entitled “Systems and methods for providing enhanced services for telecommunication call” is directed to a method for providing enhanced services for calls over Asynchronous Transfer Mode (ATM) system. Such services include voice messaging, facsimile messaging, mail boxes, voice recognition, conference bridging, calling card, menu routing, prepay card, tone detection and call forwarding. The system includes a service platform system, which interacts with a plurality of communication terminals. The service platform system includes a signaling processor, a service platform and an interworking unit.

The signaling processor receives signaling messages in ATM format from a source terminal, processes them and determines which services the call requires and which operations have to be performed. The signaling processor then sends a signal to the service platform, designating the application to use in order to process the call. The interworking unit receives signals from the source terminal and from the signaling processor, and converts the ATM cells, which it has received from the source terminal, to a form, which is compatible with the service platform. The service platform processes the signal received from interworking unit according to the selected application, and sends the processing results to the signaling processor, and the processed call to the interworking unit. The interworking unit sends the processed call either to the source terminal or to another service platform. The signaling processor sends the processed call either to the target terminal, to the source terminal or to another service platform, according to the control messages included in the processing results.

### SUMMARY OF THE DISCLOSED TECHNIQUE

It is an object of the disclosed technique to provide a novel method and system for management of telephony nodes, which overcomes the disadvantages of the prior art. In accordance with the disclosed technique, there is thus provided a network architecture for enabling a first network terminal connected in a call with a second network terminal via a first circuit, to purchase calling time during the call. The network architecture includes a first network node connected to the first network terminal and a second network node connected to the second network terminal. The network architecture further includes an account management node connected to the first network node, and a call management node connected to the first network node.

The account management node manages a pre-paid account associated with the first network terminal. The call management node is connected to the first network node via a signaling link, to the account management node via a communication link, and to the second network node. The call management node connects the first network terminal with the account management node over a second circuit, while the second network terminal is on hold, whereby the first network terminal purchases calling time. The call management node disconnects the first network terminal from the account management node, when the call-credit of the pre-paid account is positive, thereby allowing the first network terminal to resume the call.

In accordance with another aspect of the disclosed technique, there is thus provided a network architecture for terminating a first call between a first network terminal and a second network terminal over a first circuit, when a call-credit of a pre-paid account of the first network terminal is zero. The network architecture includes a first network node connected to the first network terminal, a second network node connected to the second network terminal, an account management node connected to the first network node, and a call management node. The account management node manages a pre-paid account associated with the first network terminal.

The call management node is connected to the first network node via a first signaling link, to the second network node via a second signaling link, and to the account management node via a communication link. The call management node disconnects the second network terminal from the second network node, by sending a first modified message to the second network node to dis-allocate the first circuit. The call management node establishes a second call between the first network terminal and the account management node, for the account management node to send an explanatory message to the first network terminal for terminating the first call. The call management node terminates the first call, when the call-credit is zero. The call management node produces the first modified message by replacing a destination identification code respective of the second network terminal, with a unique identification code respective of the account management node.

In accordance with a further aspect of the disclosed technique, there is thus provided a network architecture for enabling a first network terminal to increase a call-credit of a pre-paid account associated with the first network terminal, when the call-credit is approaching zero. The first network terminal has previously requested to establish a first call with a second network terminal over a first circuit.

The network architecture includes a first network node connected to the first network terminal, a second network node connected to the second network terminal, an account management node connected to the first network node, and a call management node. The account management node manages the pre-paid account. The call management node is connected to the first network node via a first signaling link, to the second network node via a second signaling link, and to the account management node via a communication link.

The call management node establishes a second call between the first network terminal and the account management node, for the first network terminal to increase the call-credit. The call management node terminates the second call when the call-credit is positive, and sends a first modified message to the second network node to allocate the first circuit. The call management node produces the first modified message by replacing a point code associated with the first network node, with another point code associated with the call management node.

In accordance with another aspect of the disclosed technique, there is thus provided a method for enabling a first network terminal connected in a call with a second network terminal via a first circuit, to purchase calling time during the call. The method includes the procedure of sending a first modified message to a network node associated with the first network terminal, for the network node to allocate a second circuit, for connecting the first network terminal with an account management node over the second circuit.

The method further includes the procedures of receiving a signaling message from the network node that the first network terminal has accepted the waiting call, and sending a command to the account management node to initiate a pre-call procedure together with the first network terminal. The method further includes the procedures of receiving a second indication from the account management node that the pre-call procedure is complete, and sending a second modified message to the network node, for the network node to dis-allocate the second circuit.

When the first modified message is sent to the network node, the network node notifies the first network terminal of a waiting call from the account management node. The command to the account management node is sent over the second circuit, while the call at the network node over the first circuit, is on hold. When the second message is sent to the network node, the first network terminal is enabled to resume the call with the second network terminal, over the first circuit.

In accordance with a further aspect of the disclosed technique, there is thus provided a method for terminating a call between a first network terminal and a second network terminal over a first circuit, when a call-credit of a pre-paid account of the first network terminal is zero. The method includes the procedure of sending a first modified message to a second network node associated with the second network terminal, to dis-allocate the first circuit, thereby disconnecting the second network terminal from the second network node.

The method further includes the procedure of sending a second modified message to the second network node, to re-allocate the first circuit for further directing the call to an account management node, for connecting the first network terminal with the account management node. The method further includes the procedure of sending a first command to the account management node to allocate a second circuit which is selected by the second network node, thereby connecting the first network terminal with the account management node over the first circuit and the second circuit.

The method further includes the procedure of sending a third modified message to the first network node, to allocate a third circuit which is selected by the second network node, thereby connecting the first network node with the second network node over the first circuit and the third circuit. The method further includes the procedure of sending a second command to the account management node to allocate a fourth circuit which is selected by the first network node, thereby connecting the first network terminal with the account management node, over the first circuit, the third circuit, and the fourth circuit. The method further includes the procedures of sending an explanatory message to the first network terminal for terminating the call, and terminating the call.

In accordance with another aspect of the disclosed technique, there is thus provided a method for enabling a first network terminal to increase a call-credit of a pre-paid account associated with the first network terminal, when the call-credit is approaching zero. The first network terminal has previously requested to establish a call with a second network terminal over a first circuit. The method includes the procedure of sending a first modified message to a second network node associated with the second network terminal, to allocate the first circuit for further directing the call to an account management node, for connecting the first network terminal with the account management node.

The method further includes the procedure of sending a second modified message to the first network node to allocate a second circuit, following allocation of the second circuit by the second network node. The method further includes the procedure of sending a first command to the account management node to allocate a third circuit, following allocation of the third circuit by the first network node, thereby connecting the first network terminal with the account management node.

The method further includes the procedure of sending a second command to the account management node to allocate a fourth circuit which is selected by the second network node, thereby connecting the first network terminal with the account management node. The method further includes the procedures of receiving a second indication from the account management node, that the call-credit is positive, and sending a third modified message to the first network node, to dis-allocate the third circuit.

The method further includes the procedures of sending a fourth modified message to the second network node, to dis-allocate the second circuit, and sending a fifth modified message to the second network node, to dis-allocate the fourth circuit. The method further includes the procedure of sending a first signaling message to the second network node, to re-allocate the first circuit, following dis-allocation of the first circuit by the second network node, thereby connecting the first network terminal with the second network terminal.

### BRIEF DESCRIPTION OF THE DRAWINGS

The disclosed technique will be understood and appreciated more fully from the following detailed description taken in conjunction with the drawings in which:

FIG. 1 is a schematic illustration of a system for placing a call between a pre-paid mobile subscriber, and a land subscriber, which is known in the art;

FIG. 2 is a schematic illustration of a system for placing a call between a pre-paid mobile subscriber, and a land subscriber, which is known in the art;

FIG. 3 is a schematic illustration of a system, constructed and operative in accordance with an embodiment of the disclosed technique;

FIG. 4 is a schematic illustration of a system, constructed and operative in accordance with another embodiment of the disclosed technique;

FIG. 5A is a schematic illustration of a message flow diagram, operative in accordance with a further embodiment of the disclosed technique, wherein a mobile terminal initiates a call;

FIG. 5B is a schematic illustration of a supplemental portion of the message flow diagram of FIG. 5A, wherein a mobile terminal terminates the call;

FIG. 5C is a schematic illustration of a supplemental portion of the message flow diagram of FIG. 5A, wherein a land terminal terminates the call;

FIG. 6 is a schematic illustration of a method for operating the call management system of FIG. 4, operative in accordance with another embodiment of the disclosed technique;

FIG. 7 is a schematic illustration of a callback message flow diagram, operative in accordance with a further embodiment of the disclosed technique;

FIG. 8 is a schematic illustration of a method for operating the call management system of FIG. 4, operative in accordance with another embodiment of the disclosed technique;

FIG. 9 is a schematic illustration of the call management system of FIG. 4, constructed and operative in accordance with a further embodiment of the disclosed technique;

FIG. 10 is a schematic illustration of a message flow diagram for terminating an on-going call between two remote network nodes, operative in accordance with another embodiment of the disclosed technique; and

FIG. 11 is a schematic illustration of a method for operating the CMS of FIG. 4, operative in accordance with a further embodiment of the disclosed technique.

FIG. 12A is a schematic illustration of a system for enabling intervening operations during an ongoing call, constructed and operative in accordance with another embodiment of the disclosed technique;

FIG. 12B is a schematic illustration of the system of FIG. 12A, in a stage which a terminal purchases calling time from the accounting module of the pre-paid system (PPS) of the system of FIG. 12A, while the call is kept on hold;

FIG. 12C is a message flow diagram illustrating some of the stages of the operation of the system of FIG. 12A;

FIG. 13A is a schematic illustration of a system, for establishing a second call between a pre-paid system and a pre-paid terminal, before the pre-paid terminal is allowed to place a first call with another terminal, constructed and operative in accordance with a further embodiment of the disclosed technique;

FIG. 13B a schematic illustration of a message flow diagram for operating the system of FIG. 13A;

FIG. 14A is a schematic illustration of a system, for establishing a second call between a pre-paid system and a pre-paid terminal, before the pre-paid terminal is allowed to place a first call with another terminal, constructed and operative in accordance with another embodiment of the disclosed technique;

FIG. 14B is a schematic illustration of a message flow diagram for operating the system of FIG. 14A;

FIG. 15 is a schematic illustration of a method for operating the system of FIG. 12A, operative in accordance with a further embodiment of the disclosed technique;

FIG. 16 is a schematic illustration of a method for operating the system of FIG. 12A, operative in accordance with another embodiment of the disclosed technique; and

FIG. 17 is a schematic illustration of a method for operating the system of either of FIG. 13A or 14A, operative in accordance with a further embodiment of the disclosed technique.

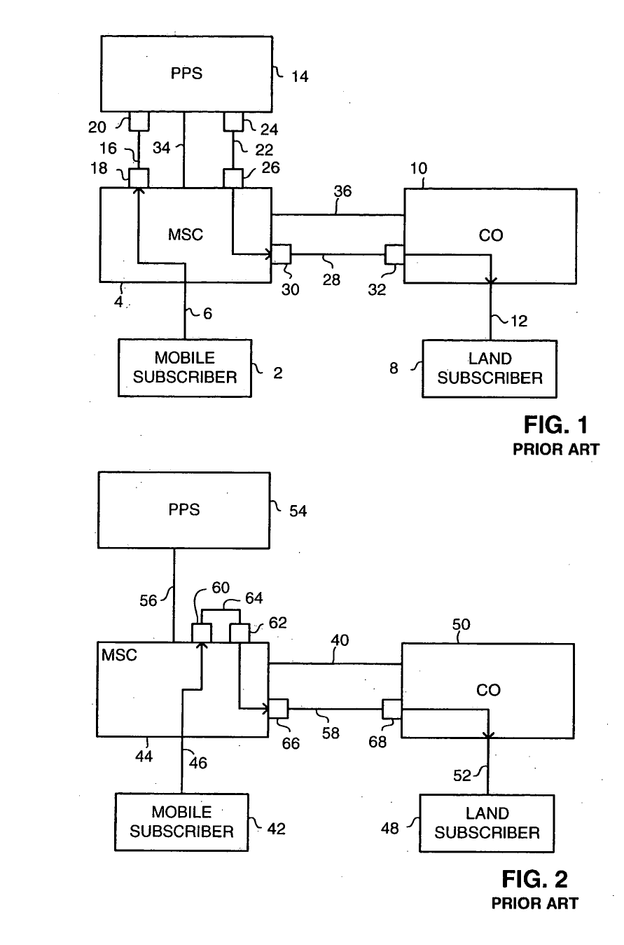

### DETAILED DESCRIPTION OF THE EMBODIMENTS

The disclosed technique overcomes the disadvantages of the prior art, by providing a telephony management architecture and method, which directs the actual call straight to the destination network node, and without conveying the actual call toward the managing network module.

Telephony nodes such as high volume switching systems (e.g., a call management system, a control center), routers and telephony control systems (e.g., a PPS) communicate with each other, using telephony protocols such as SS7. Transmitting a message from one node to another is called signaling. The ISDN user part (ISUP) layer of SS7 protocol is used for establishing circuit switched connections over which telephony calls are conveyed.

The disclosed technique provides a novel method for operating telephony nodes under SS7 like protocols, which overcomes the disadvantages of the prior art and separates between the signaling path and the call path.

In the following description, the term “signaling link”, refers to a channel for carrying signaling and control messages. The terms “connection” or “voice link” herein below refer to a channel for carrying voice/data messages.

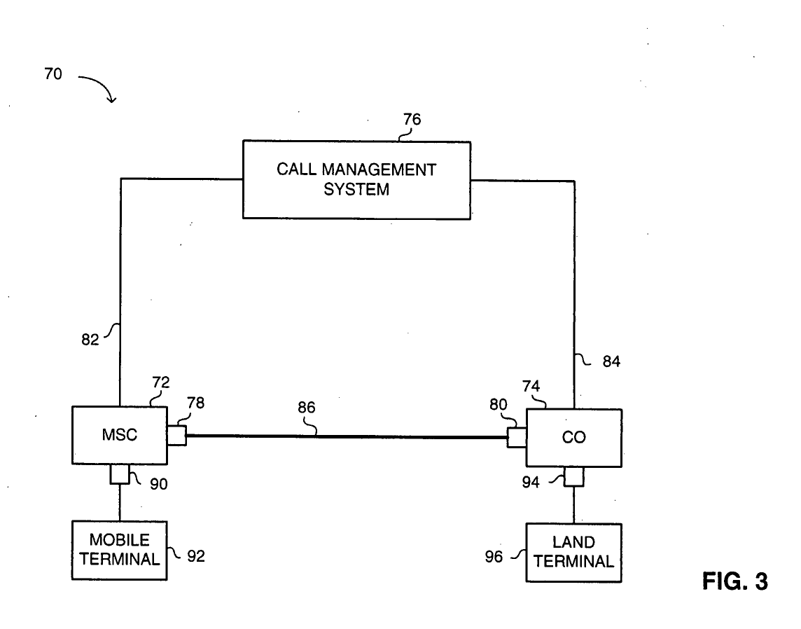

Reference is now made to FIG. 3, which is a schematic illustration of a system, generally referenced 70, constructed and operative in accordance with an embodiment of the disclosed technique. System 70 includes an MSC 72, a CO 74 and a call management system (CMS) 76. MSC 72 includes an MSC port 78. CO 74 includes a CO port 80. CO port 80 and MSC port 78 are connected by a network connection 86. FIG. 3 illustrates a simple example for a pre-paid service architecture, which reduces the number of ports in MSC 72, which are required for establishing real time monitored telephony call connection to CO 74.

MSC 72 is a telephony communication switch, which serves a plurality of mobile terminal users. CO 74 is a telephony communication switch, which serves a plurality of land terminal users. CMS 76 is a computerized system for providing and managing telephony services such as pre-paid accounts, callback architecture, and the like.

According to the disclosed technique, MSC 72 and CO 74 link to CMS 76 for the purpose of initiating and terminating a telephone call between mobile terminal 92 and land terminal 96, while being directly connected there between (i.e., without any mediation of CMS 76).

In the present example, mobile terminal 92 is associated with a pre-paid account. When mobile terminal 92 initiates a call to land terminal 96, mobile terminal 92 connects to MSC 72. MSC 72 detects that mobile terminal 92 is associated with a pre-paid account, and allocates a port 78 according to the dialed number and a call initiation request to CMS 76. The call initiation request includes source network node parameters respective of MSC 72 and destination network node parameters respective of CMS 76.

Under conventional telephony procedures, a port in one network node is rigidly connected to a respective port in another network node. Accordingly, a port through which a call is to be directed, is associated with the network node (e.g., MSC, CMS, CO and the like) to which the call initiation request is sent. Hence, in the present example, MSC 72 operates under the assumption that the call is to be directed to CMS 76, while in fact MSC 72 is coupled to CO 74.

CMS 76 authorizes the call according to the account status of mobile terminal 92, processes the information embedded in the call initiation request, determines new destination parameters and produces a new call initiation request. CMS 76 directs that new call initiation request to CO 74. The new call initiation request includes source network node parameters respective of CMS 76 and destination network node parameters respective of CO 74. CMS 76 determines the identification of the destination network node (i.e., the CO 74) from identification of the source network node and from the identification of the network connection, on which the source network node intends to direct the call. The new call initiation request is directed to receiving a call at network connection 86.

Finally, CO 74 receives the call initiation request, and directs the call from the specified network connection to the land user. Similar to the MSC 72, CO 74 operates under the assumption that the call was received from CMS 76. Hence, CO 74 will direct any signaling activity associated with that call (e.g., call termination instruction—hang up), to CMS 76. Neither MSC 72 nor CO 74 exchange signaling messages with each other, with respect to that call. Any signaling of either CO 74 or MSC 72, which affects the other, has to undergo mediation of CMS 76.

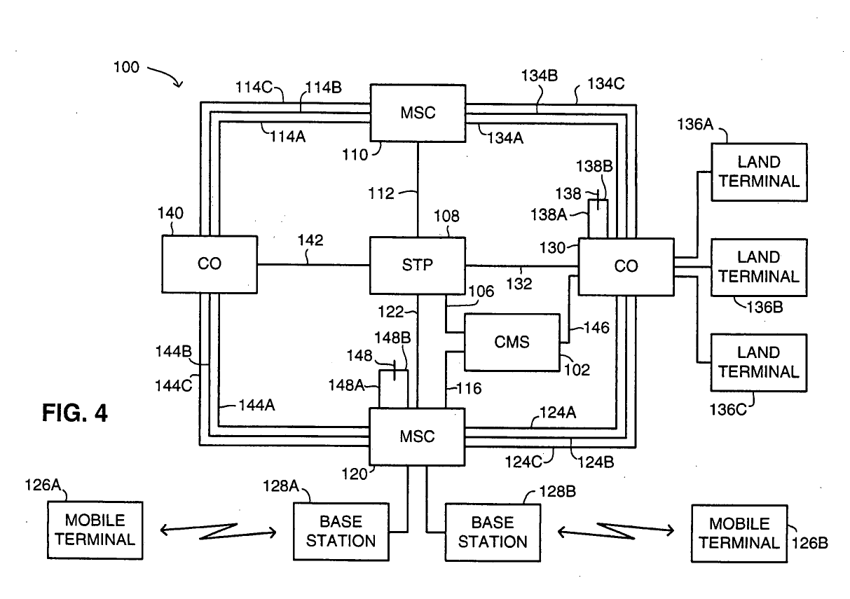

Reference is now made to FIG. 4, which is a schematic illustration of a system, generally referenced 100, constructed and operative in accordance with another embodiment of the disclosed technique. System 100 includes a plurality of network nodes among which are two mobile switching center nodes 110 and 120, two central office nodes 130 and 140 and a call management system (CMS) 102. System 100 further includes a signal transfer point (STP) 108, which is a signaling router, relaying between CMS 102 and service switching points such as nodes 110, 120, 130 and 140.

It is noted that a conventional network architecture utilizes a separate STP unit as gateway for each network node, and in most cases, more than one in parallel, so as to enhance redundancy. In addition, each of the nodes 110, 120, 130 and 140 listed above, represents a setting for a telephony operator and can be replaced by more than one of the same kind. For example, a conventional switching node such as an MSC is typically operative to manage a number of users which is in the order of a few hundreds of thousands. A wireless telephony service provider having a few million subscribers shall construct its internal network from several MSC units, coupled in parallel with an array of STP units, all served by the same CMS unit. A land telephony operator would have a similar networking structure, and would be served by a single CMS unit. None of these internal network structures is addressed in the following disclosure, although in the example set fourth in FIG. 4, CMS 102 serves two telephony providers, represented by MCS 120 and CO 130. Conventional signaling networks using STP modules can be regarded as multiple access networks (e.g., a conventional SS7 network).

In FIG. 4, each of network nodes 110, 120, 130 and 140 has a unique point code assigned thereto, which serves as identification thereof. The following is a point code table for the network nodes of FIG. 4.

TABLE 1

| Network Node | Point Code |
|---|---|
| Mobile switching center 110 | 1 |
| Mobile switching center 120 | 2 |
| Central office node 130 | 3 |
| Central office node 140 | 4 |
| Call management system 102 | 5 |

Mobile switching center nodes 110 and 120 and central office nodes 130 and 140 are coupled with management system (CMS) 102, via STP 108 and respective signaling links 112, 122, 132 and 142. STP 108 is coupled with CMS 102 via a signaling link 106. In the example set forth in FIG. 4, signaling links 106, 112, 122, 132 and 142 are SS7 trunks.

Mobile switching center node 110 is coupled with central office node 140 via multi channel connections 114A, 114B and 114C. Mobile switching center node 120 is coupled with central office node 130 via multi channel connections 124A, 124B and 124C. Mobile switching center node 110 is coupled with central office node 130 via multi channel connections 134A, 134B and 134C. Mobile switching center node 120 is coupled with central office node 140 via multi channel connections 144A, 144B and 144C. It is noted that the number of channel connections between each of the nodes may vary as well as the type and capacity of each of these channel connections. MSC 120 and CO 130 are further coupled with CMS 102 via respective multi-channel interactive voice recognition connections (IVR) 116 and 146.

In the present example, MSC 120 is further coupled with a plurality of mobile terminals 126A and 126B, via a cellular network of cellular base stations 128A and 128B. CO 130 is further connected to a plurality of land telephony terminals 136A, 136B and 136C.

MSC 120 includes a looped multi-channel connection 148 from one port thereon to another, having two sections 148A and 148B. MSC 120 considers each of sections 148A and 148B as a separate multi-channel connection, directed outwardly. CO 130 includes a looped multi-channel connection 138 from one port thereon to another, having two sections 138A and 138B. CO 130 considers each of sections 138A and 138B as a separate multi-channel connection, directed outwardly.

Each of the multi channel connections 114A, 114B, 114C, 124A, 124B, 124C, 134A, 134B, 134C, 144A, 144B and 144C is operative to convey a plurality of communication sessions such as telephone calls, using multiplexed communication. For example, channel connection 114A is an E1 type trunk, which defines a plurality of time slots thereon, where each time slot can be assigned to a different telephone call session. A circuit identification code (CIC) points to a specific one of these time slots. In a selected network node, a circuit identification code uniquely defines the multi-channel connection assigned thereto, in a plurality of multi-channel connections directed to a selected other network node. The following is a CIC allocation Table for MSC 120.

TABLE 2

| CIC | Channel Connection | Point Code |
|---|---|---|
| 100-399 | 124A | 5 |
| 400-999 | 124B | 5 |
| 1000-1299 | 124C | 3 |
| 1300-1499 | 144A | 5 |
| 1500-2200 | 144B | 4 |
| 3000-3999 | 144C | 4 |
| 2000-2499 | 148A | 5 |
| 2500-2999 | 148B | 5 |

The following is a CIC allocation Table for CO 130.

TABLE 3

| CIC | Channel Connection | Point Code |
|---|---|---|
| 100-399 | 124A | 5 |
| 1400-1999 | 124B | 5 |
| 2000-2299 | 124C | 5 |
| 3000-3499 | 134A | 5 |
| 100-999 | 134B | 1 |
| 1000-1999 | 134C | 1 |
| 2300-2499 | 138A | 5 |
| 2500-2699 | 138B | 5 |

As can be seen from the above Tables 2 and 3, the disclosed technique allows for various network nodes to have different circuit identification codes for the same trunk. For example, MSC 120 assigns circuit identification codes in the range 400-999 for network connection (trunk) 124B, while CO 130 assigns circuit identification codes in the range 1400-1999 for that same network connection.

Furthermore, the disclosed technique provides non symmetrical relations, such as in the case of multi channel connection 124C. When node 120 initiates a call on multi channel connection 124C, node 120 signals directly to node 130. But when node 130 initiates a call on multi channel connection 124C, node 130 signals to CMS 102. Such a case may exist in a pre-paid architecture, where the recipient (connected to node 120) pays for incoming calls as well. In that case, node 120 can direct calls of non pre-paid terminals directly to node 130 using multi channel connection 124C.

Node 130, however, not containing any information relating to terminals connected to node 120, cannot distinguish between a pre-paid mobile terminal and a non pre-paid one. Hence, when a mobile terminal pays for incoming calls, the call can be directed in two ways. The first way is using the disclosed technique, whereby node 130 establishes a signaling link with CMS 102 and operates as if the voice links are connected to CMS 102. CMS 102 detects if the destination terminal is associated with a pre-paid account and manages the call accordingly. The second way uses conventional methods where node 130 establishes a signaling link to node 120, which then directs the signaling link to CMS 102, using a full voice connection or a looped around connection.

This flexibility of assignment of circuit identification codes is achieved by including a special look-up table in CMS 102, which can determine a destination point code (DPC) and a circuit identification code thereof according to the originating point code and the circuit identification code the originating point code (OPC). The following is a partial example of such a look-up table, respective of the network connection which exists between MSC 120 and CO 130.

TABLE 4

| | | |
|---|---|---|
| Origin | Network | Destination |

| OPC | CIC | Connection | DPC | CIC |
|---|---|---|---|---|
| 2 | 100-399 | 124A | 3 | 100-399 |
| 2 | 400-999 | 124B | 3 | 1400-1999 |
| 3 | 100-399 | 124A | 2 | 100-399 |
| 3 | 1400-1999 | 124B | 2 | 400-999 |
| 3 | 2000-2299 | 124C | 2 | 1000-1299 |
| 2 | 2000-2499 | 148 | 2 | 2500-2999 |
| 2 | 2500-2999 | 148 | 2 | 2000-2499 |
| 3 | 2300-2499 | 138 | 3 | 2500-2699 |
| 3 | 2500-2699 | 138 | 3 | 2300-2499 |

It is noted that when two network nodes define the same circuit identification code, for all of the network connections there between, as in the case of trunk 124A, the column of the destination circuit identification code can be eliminated, since this information already exists in the origin circuit identification code column.

When one network node has to establish a telephone call connection to another network node, it sends a call initiation request to that other network node including a plurality of parameters, such as source, destination, and the like.

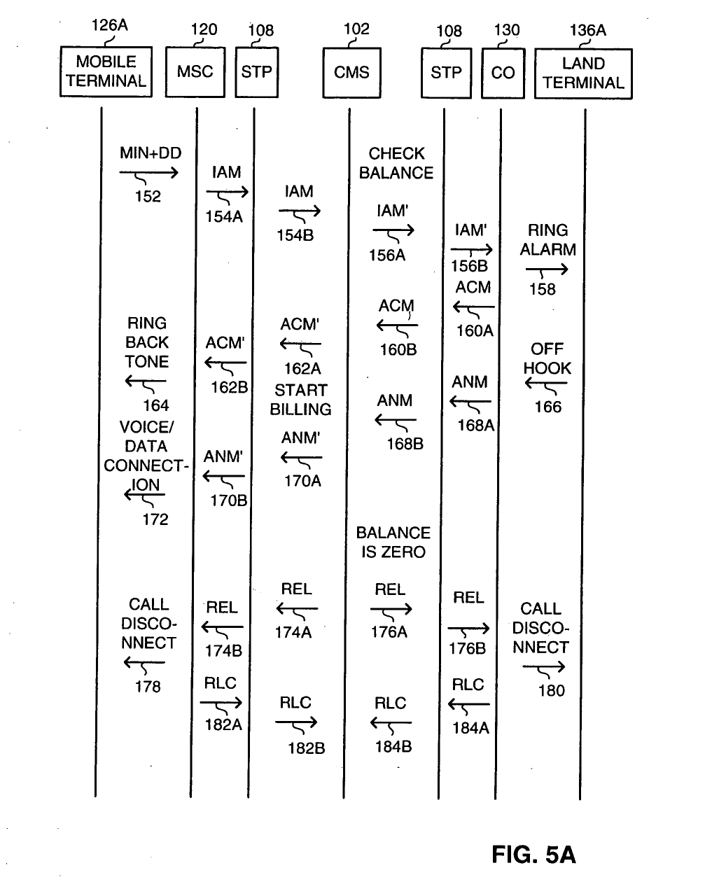

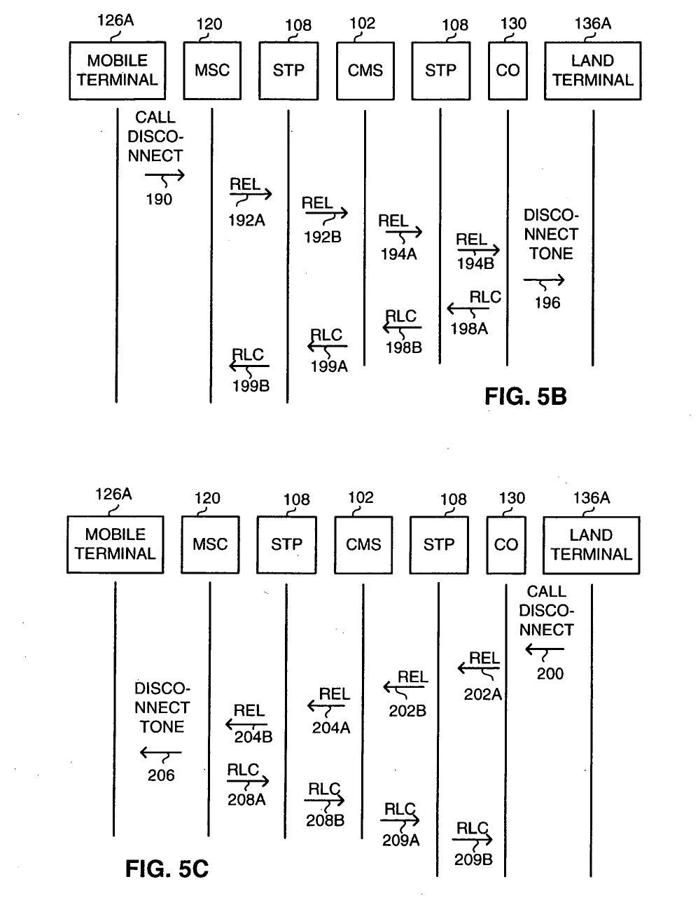

Reference is further made to FIG. 5A, which is a schematic illustration of a message flow diagram, operative in accordance with a further embodiment of the disclosed technique, wherein a mobile terminal initiates a call. The flow diagram presented in FIG. 5A is an example of an implementation of the disclosed technique, in SS7 protocol. In SS7 protocol, a call initiation request is called an initial address message (IAM), and includes a plurality of data fields, among which are the following:

Originating point code (OPC), which is the identification of the network node, which originated the message.

Destination point code (DPC), which is the identification of the network node, to which the message is sent.

Circuit identification code (CIC), which is the identification of the physical network connection, on which the call is supposed to be established.

Dialed digits (DD).

Calling line identifier (CLI), which is the phone number of the subscriber that originated the call.

The message flow diagram of FIG. 5A provides an example for establishing a telephone call between mobile terminal 126A and land terminal 136A, where mobile terminal 126A is associated with a pre-paid program. Hence, all calls which are billed to mobile terminal 126A have to be monitored in real time, so as to determine if at one point in time the cost of the call exceeds the credit in the account of mobile terminal 126A and further to provide warning beforehand.

Mobile terminal 126A connects to MSC 120 and provides the mobile identification number (MIN) thereof, as well as dialed digits (DD) which the mobile terminal user keyed in (referenced 152). In the present example, the dialed digits include the identification number of land terminal 136A, which may also include a prefix respective of CO. MSC 120 detects that mobile terminal 126A is associated with a pre-paid account. This can be achieved for example, by assigning a predetermined range of numbers for all of the pre-paid mobile terminals, assigned to MSC 120. It is noted that if the mobile terminal is associated with a regular account (i.e., not a pre-paid), then MSC 120 can establish a call directly to the destination node without the mediation of CMS 102 (e.g., a call from mobile terminal 126B, which has regular account, to land terminal 136A, may be performed by using conventional signaling directly to CO 130, allocating a CIC on trunk 124C).

MSC 120 allocates a CIC for that call, produces an initial address message (IAM) referenced 154A and directs this IAM to CMS 102. STP 108 routes IAM 154A to CMS 102 as IAM 154B. The content of IAM 154A and IAM 154B is substantially identical. The IAM message includes the following parameters:

IAM (MSC-CMS)

| OPC | DPC | CLI | DD | CIC_{OPC} |
|---|---|---|---|---|
| 2 | 5 | 456456 | 789789 | 500 |

It is noted that the term CIC_{OPC} and the term CIC_{DPC}, which will be presented further below, are unique for the disclosed technique, since the signaling protocol portion of SS7 does not distinguish between the CIC of the originating node and the CIC of the destination node. These terms are used in the disclosed technique for explanation purposes only. It is noted that MSC 120 operates under the assumption that CIC 500 is used for connecting to CMS 102, as specified in the above Table 2.

CMS 102 receives IAM 154B, detects that the calling subscriber is a pre-paid one, according to the CLI content and authorizes the call according to the status of the account. CMS 102 further accesses Table 4 with the received OPC and CIC_{OPC} parameters and retrieves the respective DPC and CIC_{DPC} parameters, which are DPC=3 and CIC_{DPC}=1 500.

CMS 102 produces a new initial address message (IAM′) referenced 156A, and directs it to CO 130. STP 108 routes IAM′ 156A to CO 130 as IAM′ 156B. The content of IAM′ 156A and IAM′156B is substantially identical. The IAM′ 156A message includes the following parameters:

IAM′ (CMS-CO)

| OPC | DPC | CLI | DD | CIC_{DPC} |
|---|---|---|---|---|
| 5 | 3 | 456456 | 789789 | 1500 |

CO 130 receives the IAM′, allocates CIC 1500 and detects the current state of land terminal 136A (i.e., on-hook, off-hook, and the like). When land terminal 136A is available for receiving the call, then CO 130 initiates a ring alarm, referenced 158, at land terminal 136A and provides acknowledgement to the node which requested the call (i.e., CMS 102) in the form of an address complete message (ACM) 160A. It is noted that CO 130 operates under the assumption that CIC 1500 is used for connecting to CMS 102, as specified in the above Table 3. STP 108 routes ACM 160A to CMS 102 as ACM 160B. The content of ACM 160A and ACM 160B is substantially identical. The ACM 160A message includes the following parameters:

ACM (CO-CMS)

| OPC | DPC | CIC_{DPC} |
|---|---|---|
| 3 | 5 | 1500 |

CMS 102 receives the ACM 160B from CO 130, produces a new address complete message (ACM′) 162A and directs it to MSC 120. STP 108 routes ACM′ 162A to MSC 120 as ACM′ 162B. The content of ACM′ 162A and ACM′ 162B is substantially identical.

The ACM message includes the following parameters:

ACM′ (CMS-MSC)

| OPC | DPC | CIC_{DPC} |
|---|---|---|
| 5 | 2 | 500 |

MSC 120 receives ACM′ 162B and initiates a ring back tone for the mobile terminal 126A. When the user at land terminal accepts the call and picks up the phone, then land terminal 136A sends an answer message (ANM) 166 to CO 130, which in turn directs it to CMS 102 via STP 108 (references 168A and 168B).

At this point, CMS 102 starts billing the account associated with mobile terminal 126A. It is noted that the actual billing record can be made retroactively to the point in time where CMS 102 received IAM 154B, or to any other point, according to the billing policy associated with that account.

CMS 102 translates the OPC, DPC and CIC parameters of the received ANM, produces a new ANM′ referenced 170A and directs it to MSC 120 via STP 108 (referenced 170B). At this point, both MSC 120 and CO 130 use the same voice link using respective circuit identification codes (500 and 1500, respectively), and a voice telephone call (referenced 172) is established between mobile terminal 126A and land terminal 136A.

It is noted that according to the architecture of the disclosed technique, MSC 120 allocates only two CICs, one for mobile terminal 126A and another for connecting to CO 130. No CIC is allocated to or from CMS 102, by either node. Hence, the architecture of the disclosed technique significantly reduces the amount of network resources, which have to be allocated for establishing a real-time monitored call such as one of a pre-paid service.

As stated above, MSC 120 as well as CO 130, operate under the assumption that the node at the other end is CMS 102 and hence direct all signaling messages thereto. Since CMS 102 receives all of the signaling messages provided by these two nodes 120 and 130, it is able to monitor every logical aspect of the call. CMS 102 starts billing the pre-paid account when these nodes provide notification that a call was established there between. CMS 102 can stop billing when one of the nodes provides notification that the terminal connected thereto, is in “hang-up” status. Measuring the time length of the call, CMS 102 can detect when the account reaches a balance of zero, provide warning thereto beforehand via multi-channel interactive voice recognition connection 116, and terminate the call as will be described herein below.

When CMS 102 detects that the account reaches a balance of zero, it produces two release messages (REL) 174A and 176A to MSC 120 and CO 130, respectively. STP routes RELS 174A and 176A to their respective destination nodes as REL messages 174B and 176B. When MSC 120 receives REL 174B, it dis-allocates CIC 500, thereby disconnecting (referenced 178) the call for mobile terminal 126A, and further sends a release complete message (RLC) 182A to CMS 102, via STP 108. The RLC 182A message includes the following parameters:

RLC (MSC-CMS)

| OPC | DPC | CIC_{DPC} |
|---|---|---|
| 2 | 5 | 500 |

When CO 130 receives REL 176B, it dis-allocates CIC 1500, disconnects (reference 180) the call for land terminal 136A, and further sends a release complete message (RLC) 184A to CMS 102, via STP 108. STP routes RLC messages 182A and 184A as RLC messages 182B and 184B. RLC 184A message includes the following parameters:

RLC (CO-CMS)

| OPC | DPC | CIC_{DPC} |
|---|---|---|
| 3 | 5 | 1500 |

CMS 102 receives RLC messages 182B and 184B as confirmations that both nodes terminated the call and that the respective CICs are not allocated.

Reference is further made to FIG. 5B, which is a schematic illustration of a supplemental portion of the message flow diagram of FIG. 5A, wherein a mobile terminal terminates the call. The sequence presented in the flow diagram of FIG. 5B commences right after the voice/data connection state 172 of FIG. 5A, instead of the call termination sequence portion which starts at stage 174A and ends at stage 184B.

When the mobile user performs a “hang-up” operation (e.g., presses END button, closes flipper portion of the phone, and the like) for indicating his intention for terminating the telephone call session, mobile terminal 126A sends MSC 120 a call disconnect message 190. MSC 120, operating under the assumption that he is connected to CMS 102, transmits a REL message 192A to CMS 102 via STP 108. STP 108 routes REL message 192A to CMS 102, as a REL message 192B. MSC 120 further dis-allocates CIC 500. The REL 192A message includes the following parameters:

REL (MSC-CMS)

| OPC | DPC | CIC_{OPC} |
|---|---|---|
| 2 | 5 | 500 |

CMS 102 receives the REL 192B from MSC 120, produces a release message (REL) 194A and directs it to CO 130, via STP 108. STP 108 routes REL 194A to CO 130 as REL 194B. REL 194A message includes the following parameters:

REL (CMS-CO)

| OPC | DPC | CIC_{DPC} |
|---|---|---|
| 5 | 3 | 1500 |

When CO 130 receives REL 194B, it dis-allocates CIC 1500, thereby disconnecting (referenced 196) the call for land terminal 136A. Operating under the assumption that CIC 1500 is connected to CMS 102, CO 130 further sends a release complete message (RLC) 198A to CMS 102, via STP 108. STP routes RLC message 198A to CMS 102 as RLC message 198B. The RLC 198A message includes the following parameters:

RLC (CO-CMS)

| OPC | DPC | CIC_{DPC} |
|---|---|---|
| 3 | 5 | 1500 |

CMS 102 receives RLC message 198B as confirmations (i.e., together with RLC 192B) that both nodes terminated the call and that the respective CICs are not allocated. To complete the sequence, MSC 120 has to receive confirmation that the other party has released the call. Accordingly, CMS 102 produces and sends an RLC message 199A to MSC 120, via STP 108. STP 108 routes RLC message 199A to MSC 120 as RLC message 199B. The RLC 199A message includes the following parameters:

RLC (CMS-MSC)

| OPC | DPC | CIC_{OPC} |
|---|---|---|
| 5 | 2 | 500 |

MSC 120 receives RLC 199B and dis-allocates CIC 500 for that call.

Reference is further made to FIG. 5C, which is a schematic illustration of a supplemental portion of the message flow diagram of FIG. 5A, wherein a land terminal terminates the call. The sequence presented in the flow diagram of FIG. 5C commences right after the voice/data connection state 172 of FIG. 5A, and instead the call termination sequence portion which starts at stage 174A and ends at stage 184B.

When the land terminal user hangs up land terminal 136A for terminating the telephone call session, land terminal 136A sends CO 130 a call disconnect message 200. CO 130, operating under the assumption that CIC 1500 is connected to CMS 102, transmits a REL message 202A to CMS 102 via STP 108. STP 108 routes REL message 202A to CMS 102, as a REL message 202B. CO 130 further dis-allocates CIC 1500. The REL 202A message includes the following parameters:

REL (CO-CMS)

| OPC | DPC | CIC_{DPC} |
|---|---|---|
| 3 | 5 | 1500 |

CMS 102 receives REL 202B from STP 108, produces a release messages (REL) 204A and directs it to MSC 120, via STP 108. STP 108 routes REL 204A to MSC 120 as REL 204B. At this point, CMS 102 may stop billing the account of mobile terminal 126A. REL 204A message includes the following parameters:

REL (CMS-MSC)

| OPC | DPC | CIC_{OPC} |
|---|---|---|
| 2 | 5 | 500 |

When MSC 120 receives REL 204B, it dis-allocates CIC 500, thereby disconnecting (referenced 206) the call for mobile terminal 126A. Operating under the assumption that CIC 500 is connected to CMS 102, MSC 120 further sends a release complete message (RLC) 208A to CMS 102, via STP 108. STP routes RLC message 208A to CMS 102 as RLC message 208B. The RLC 208A message includes the following parameters:

RLC (MSC-CMS)

| OPC | DPC | CIC_{OPC} |
|---|---|---|
| 2 | 5 | 500 |

CMS 102 receives RLC message 208B as confirmations (i.e., together with RLC 202B) that both nodes terminated the call and that the respective CICs are not allocated. To complete the sequence, CO 130 has to receive confirmation that the other party has released the call. Accordingly, CMS 102 produces and sends an RLC message 209A to CO 130, via STP 108. STP routes RLC message 209A to CO 130 as RLC message 209B. RLC 209A message includes the following parameters:

RLC (CMS-CO)

| OPC | DPC | CIC_{DPC} |
|---|---|---|
| 5 | 3 | 1500 |

CO 130 receives RLC 209B and dis-allocates CIC 1500 for that call.

It is important to note that the management of that call at network level, remains at all times in the hands of CMS 102. Hence, CMS 102 significantly reduces the load over the switches, which initiate the calls.

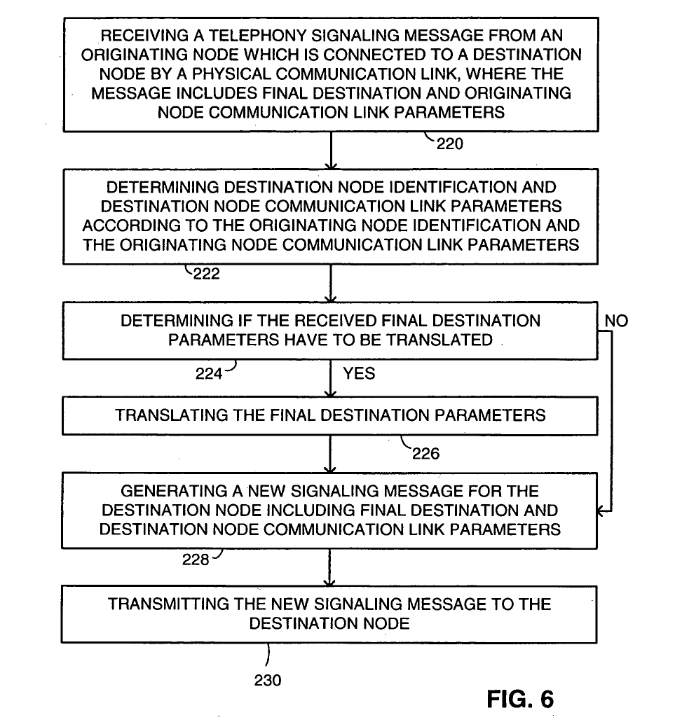

Reference is further made to FIG. 6, which is a schematic illustration of a method for operating CMS 102 of FIG. 4, operative in accordance with another embodiment of the disclosed technique. In procedure 220, a telephony-signaling message is received from an originating node, which is connected to a destination node by a physical communication link. The telephony signaling message includes final destination and originating node communication link parameters.

With reference to FIGS. 4, 5A, 5B and 5C, IAM 154B is one example of such a message. CMS 102 receives IAM 154B (alias 154A) sent by MSC 120, which is actually coupled with CO 130, where the message includes CIC parameters which are associated with multi channel connection 124A. Other examples of such a received message include ACM 160B, RLC 182B, RLC 184B, RLC 192B, RLC 198B, RLC 202B and RLC 208B.

In procedure 222, destination node identification and destination node communication link parameters are determined, according to the originating node identification and the originating node communication link parameters. With reference to FIG. 4, CMS 102 accesses Table 4, and retrieves the DPC and CIC_{DPC} parameters therefrom.

It is noted that CMS 102 can further include a dialed number translation Table, for example for translating an “800” number, which is typically virtual, to a respective regular number. In such a case, CMS 102 accesses a translation Table, and determines if the destination number, which was embedded in DD portion of the CLI, has to be translated (procedure 224). When translation is required, CMS 102 translates (procedure 226) the received number embedded in the DD portion of the CLI and provides the respective destination telephone number in the IAM′ which is later sent to the destination node. Otherwise, CMS 102 proceeds to procedure 228.

In procedure 228, a new signaling message is generated for the destination node. The new signaling message includes final destination and destination node communication link parameters. With reference to FIGS. 5A, 5B and 5C, IAM′ 156A is one example of such a message. CMS 102 transmits IAM′ 156A (which is further directed and received as IAM′ message 156B) to CO 130, where CO 130 is actually connected to MSC 120. IAM′ 156A includes CIC parameters of a CIC, which is associated with multi channel connection 124A. Other examples of such a message include ACM′ 162A, ANM′ 170A, REL 174A, REL 176A, REL 194A and REL 204A.

In procedure 230, the new signaling message is transmitted to the destination node. With reference to FIG. 4, CMS 102 transmits the newly converted message to the node 130, via STP 108.

The disclosed technique also provides the establishment of pre-paid calls within a specific node (e.g., from one subscriber to another, where both are connected to the same node). In the following example, land terminal 136C calls land terminal 136B. CO 130, sends an IAM message to CMS 102 including the following parameters:

IAM (CO-CMS)

| OPC | DPC | CLI | DD | CIC_{OPC} |
|---|---|---|---|---|
| 3 | 5 | 456456 | 456457 | 2330 |

As described above, CO 130 operates under the assumption that CIC 2330 is used for connecting to CMS 102, as specified in Table 3 above.

CMS 102 receives the IAM, detects that the calling subscriber is a pre-paid one, according to the CLI content and authorizes the call according to the status of the account. CMS 102 further accesses Table 4 with the received OPC and CIC_{OPC} parameters and retrieves DPC and respective CIC_{DPC} parameters, which are DPC=3 and CIC_{DPC}=2530.

CMS 102 produces a new initial address message, and directs it to CO 130. The IAM′ message includes the following parameters:

IAM' (CMS-CO)

| OPC | DPC | CLI | DD | CIC_{DPC} |
|---|---|---|---|---|
| 5 | 3 | 456456 | 456457 | 2530 |

CO 130 receives the IAM′, allocates CIC 2530 and detects the current state of land terminal 136B (i.e., on-hook, off-hook, and the like). The rest of the process is similar to the one described in conjunction with FIG. 5A, only that CO 130 replaces MSC 120. The result is that CMS 102 establishes a call in CO 130, between land terminals 136B and 136C, over multi-channel connection 138.

When a terminal of a network switching node requests establishment of voice telephony communication with another terminal of the same network switching node, the above procedure is performed using looped multi-channel connection 148 (FIG. 4) at that network switching node. For example, when mobile terminal 126A, associated with a pre-paid account, calls mobile terminal 126B, then MSC 120 signals to CMS 102, with a CIC associated with section 148A. CMS 102 translates that CIC to a respective CIC associated with section 148B, and establishes a voice link between mobile terminal 126A and mobile terminal 126B. It is noted that during this procedure, MSC 120 operates under the assumption that one call is directed from mobile terminal 126A toward CMS 102 and another call is directed from CMS 102 to mobile terminal 126B. Furthermore, MSC 120 holds no record for relating between these two calls, which are hence managed by CMS 102. A similar procedure can be performed over looped multi-channel connection 138 with respect to land terminals 136A, 136B and 136C.

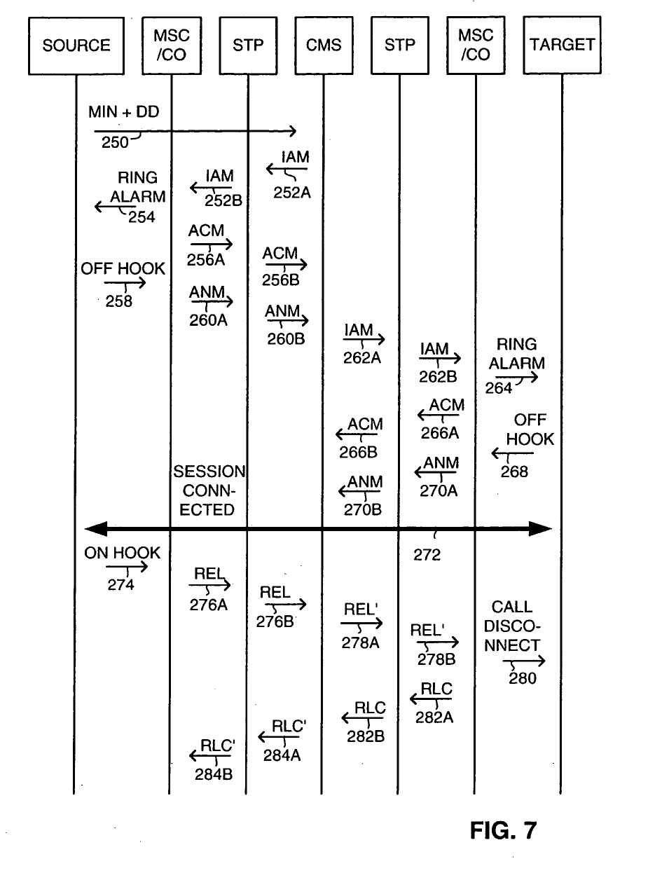

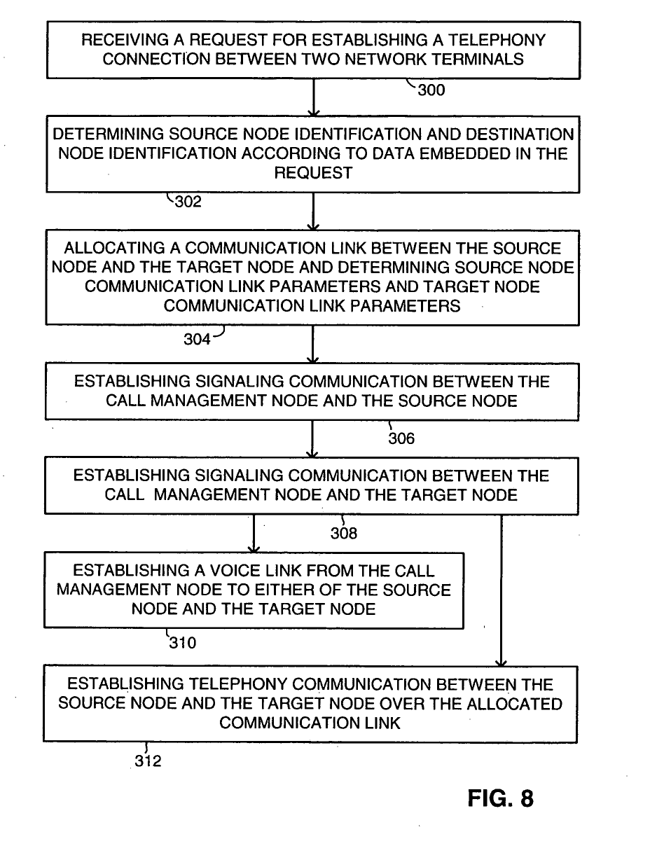

Reference is now made to FIGS. 7 and 8. FIG. 7 is a schematic illustration of a callback message flow diagram, operative in accordance with a further embodiment of the disclosed technique. FIG. 8 is a schematic illustration of a method for operating CMS 102 of FIG. 4, operative in accordance with another embodiment of the disclosed technique.

The method presented in FIG. 8 addresses a case where the call management system conducts the signaling procedures for both of the nodes, which are to be connected. In the example set forth in FIG. 7, the request for establishing the call is received from one of the nodes to be connected, although it could be received from any other source, such as a web related module (a web site), an external database, and the like.

The flow of FIG. 7 can be executed in a networking architecture such as presented in FIG. 4, for establishing a callback session between any two terminals, each being connected to a network switching node (e.g., each node can either be an MSC or a CO). The example presented in FIG. 7 addresses a situation for establishing a callback session between land terminal 136A of CO 130 and mobile terminal 126B of MSC 120.

In procedure 300, a request for establishing a telephony connection between two network terminals is received. With reference to FIGS. 4 and 7, at first, the user (e.g., the user of land terminal 136A) sends a request 250 to the CMS, for establishing a callback session, where the message includes the mobile identification number (MIN) and the dialed digits (DD). These parameters identify the source and target, which are to be connected. The request is sent digitally by means, which may be included as a service in the telephony system, such as SMS, or external thereto, such as from an Internet web-site.

In procedure 302, a source node identification and a target node identification are determined according to the data embedded in the request. With reference to FIG. 4, CMS 102 accesses Table 4 and determines a source node (of the requesting party) and a target node (for the target), according to the data embedded in the request. After determining the identification of the source node and the target node, a communication link is allocated and respective communication parameters for both the source node and the target node are determined (procedure 304). It is noted that the terms source and target can refer to a plurality of situations where one of these nodes is connected to a terminal which is to participate in the final call and the other node is merely a gateway through which the call is to be further transferred to another network, such as in the case of international calls. In the example of an international callback account, CMS 102 allocates a voice communication link between the final destination terminal node and the international telephony gateway associated with the callback account. The international telephony gateway has to further establish the route to the terminal of the user associated with the callback account and provide confirmation thereof, to CMS 102.

With reference to FIG. 4, CMS 102 can retrieve these parameters and perform the initial allocation therein, using Table 4. The physical allocation is performed later in the source and target nodes, according to the parameters provided from CMS 102.

In procedure 306, signaling communication is established between the call management node and the source node. With reference to FIGS. 4 and 7, CMS 102 produces an IAM message 252A and directs it to the source terminal network-switching node (e.g., CO 130), via STP 108. STP 108 routes the IAM message 252A to CO 130 as an IAM message 252B, where both IAM messages are substantially identical. The IAM message includes the following parameters:

IAM (CMS-CO)

| OPC | DPC | CLI | DD | CIC_{OPC} |
|---|---|---|---|---|
| 5 | 3 | 456456 | 987987 | 1700 |

CO 130 receives the IAM 252B message, initiates a ring alarm (referenced 254) at the source terminal (i.e., land terminal 136A), generates an ACM message 256A and directs it to CMS 102 via STP 108. STP 108 routes ACM message 256A to CMS 102 as ACM message 256B, where both ACM messages are substantially identical. At this stage, the user of the land terminal 136A responds to the ring alarm and sets the terminal off-hook (referenced 258). In turn, CO 130 produces an ANM message 260A and directs it to CMS 102, via STP 108. STP 108 routes the ANM message 260A to CMS 102 as an ANM message 260B, where both ANM messages are substantially identical.

In procedure 308, signaling communication is established between the call management node and the target node. With reference to FIGS. 4 and 7, CMS 102 receives ANM 260B and in turn, produces another IAM message 262A and directs it to the target source terminal network-switching node (e.g., MSC 120), via STP 108. STP 108 routes the IAM message 262A to MSC 120 as an IAM message 262B, where both IAM messages are substantially identical. The IAM message includes the following parameters:

IAM (CMS-MSC)

| OPC | DPC | CLI | DD | CIC_{OPC} |
|---|---|---|---|---|
| 5 | 2 | 987987 | 456456 | 700 |

MSC 120 receives the IAM 262B message, initiates a ring alarm (referenced 264) at the target terminal (i.e., mobile terminal 126B), generates an ACM message 266A and directs it to CMS 102 via STP 108. STP 108 routes ACM message 266A to source terminal network switching node as an ACM message 266B, where both ACM messages are substantially identical. At this stage, the user of the mobile terminal 126B responds to the ring alarm and sets the terminal off hook (referenced 268). In turn, MSC 120 produces an ANM message 270A and directs it to CMS 102, via STP 108. STP 108 routes the ANM message 270A to CMS 102 as an ANM message 270B, where both ANM messages are substantially identical.

In procedure 310, a voice link is established from the call management node to either of the source node and the target node. This voice link can be used for inducing voice messages between the network management node and a terminal connected to either the source or target nodes, or for receiving further commands from the users operating the terminals connected to either of the source or the target nodes.

In procedure 312, telephony communication is established between the source node and the target node over the allocated communication link. With reference to FIGS. 4 and 7, at this point, a session is established between CO 130 (CIC 1700) and MSC 120 (CIC 700), over multi-channel connection 124B, where each of CO 130 and MSC 120 operates under the assumption that it is coupled to CMS 102.

A telephony connection release can be initiated according to a plurality of procedures, initiated either by each of the terminals involved in that connection or by the call management node (CMS 102), similar to those described in conjunction with FIGS. 5A, 5B and 5C. The following example addresses a procedure in which the user operating the source terminal, initiates the telephony connection release, by setting his terminal to be “On Hook” (referenced 274). In turn, the source node produces a REL command 276A and directs it to CMS 102 via STP 108 as REL 276B. It is noted that the source node operates under the assumption that it is connected to CMS 102 by the voice trunk.

CMS 102 receives REL 276B, translates the source and destination parameters, produces a REL′ 278A and directs it to the target node via STP 108, as REL′ 278B. The target node disconnects the call (referenced 280), produces an RLC message 282A and directs it to CMS 102 via STP 108, as RLC 282B. CMS 102 receives RLC 282B, translates the source and destination parameters embedded therein, produces an RLC′ 284A and directs it to the source node via STP 108, as RLC′ 284B. The source node receives RLC′ 284B as confirmation, which enables final dis-allocation of the telephony resources (i.e., the CIC).

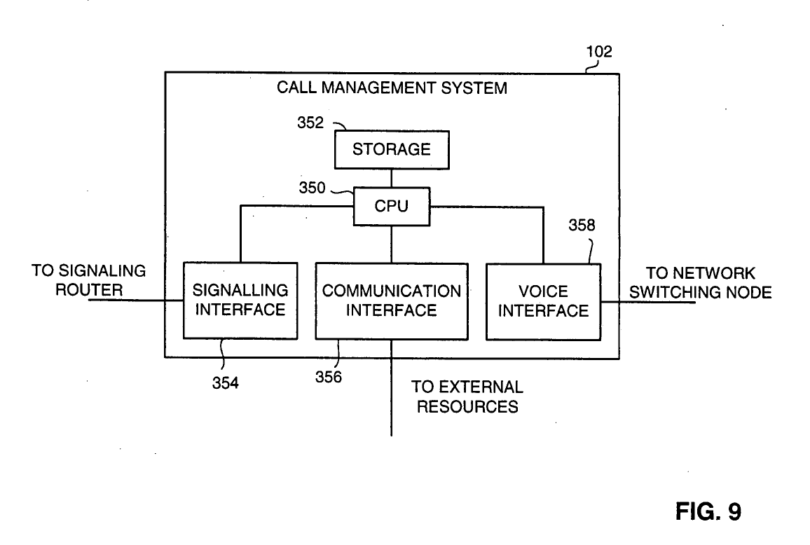

Reference is further made to FIG. 9, which is a schematic illustration of call management system 102 of FIG. 4, constructed and operative in accordance with a further embodiment of the disclosed technique. CMS 102 includes a CPU 350, a storage unit 352, a signaling interface 354, a voice interface 358 and a general communication interface 356. CPU 350 is coupled with storage unit 352, signaling interface 354, voice interface 358 and with general communication interface 356. Signaling interface 354 further is coupled with a telephony-signaling network, typically via a routing architecture using STP modules. It is noted that signaling interface 354 can be used for establishing signaling communication with a plurality of nodes due to the routed nature of signaling communication.

Voice interface 358 is used for coupling with selected network nodes, for the purpose of exchanging voice elements with the user of a selected terminal, via dedicated voice channels such as the ones referenced 116 and 146 in FIG. 4. Such voice exchange can include vocal alerts which are provided to the user, respective of the account state thereof, vocal informative messages for notifying the user of the status of the call or the terminal at the other end, requests which are directed to the user for providing specific commands to the call management system, and the like. Accordingly, voice interface 358 can further be used for receiving commands from the user, either using dual tone multiple frequency (DTMF) signals or by using voice recognition and analysis procedures. General communication interface 356 is used for connecting to external modules such as databases, supervision nodes, and the like. Call management system 102 is a node, which controls and manages telephony calls using signaling communication, without conveying the actual call there through. Network nodes, which communicate with CMS 102 using signaling communication, operate under the assumption that they are also coupled with CMS 102 by telephony voice trunks.

In the above disclosed technique, the call management system manages a call, while being a node which the other nodes are aware of, either as the originating node or the destination node. According to another aspect of the disclosed technique, the call management system is operative to manage a call, while non of the other nodes, participating in the call, are aware of its existence. According to this aspect of the disclosed technique, the call management system produces signaling nodes, which do not include any indication of the point code thereof.

The above disclosed technique can be used for rerouting telephone calls, according to various parameters. For example, CMS 102 can be used for managing an eight hundred (800) number routing service. In this case, a switching network node provides the 800 number as dialed by the user at the terminal connected thereto, to CMS 102. This number is conventionally a virtual number, which does not exist on any network node and has to be translated to a physical line. CMS 102 analyses the dialed digits and determines a destination network node and terminal number within the destination node, which are associated with that virtual number. CMS 102 further determines a CIC for the origin node and the destination node and provides it to the destination node together with the terminal number. It is noted that the terminal number can be a selected line within a trunk of lines, which for example is coupled to a call center private branch exchange (PBX). At the same time, CMS 102 notifies the originating node with respect to the selected CIC.

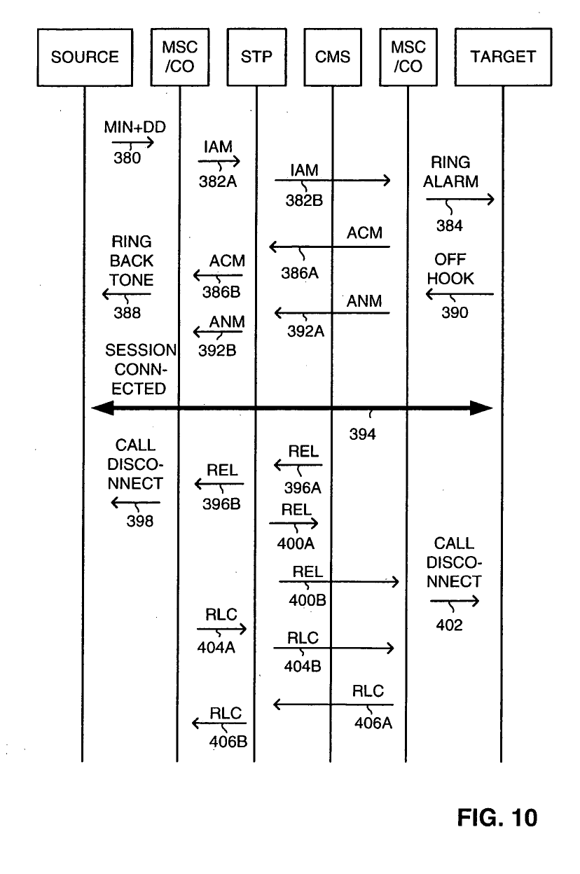

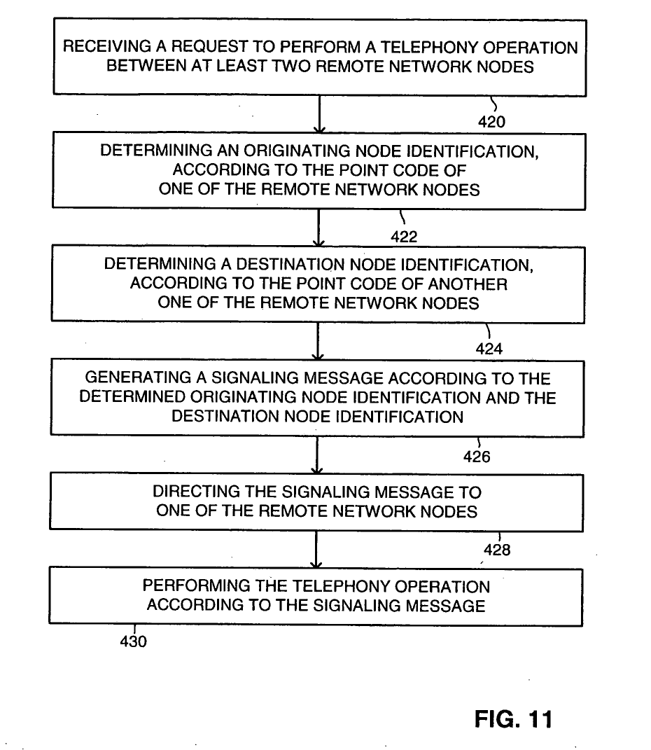

Reference is now made to FIGS. 10 and 11. FIG. 10 is a schematic illustration of a message flow diagram for terminating an on-going call between two remote network nodes, operative in accordance with another embodiment of the disclosed technique. FIG. 11 is a schematic illustration of a method for operating CMS 102 of FIG. 4, operative in accordance with a further embodiment of the disclosed technique.

The call is previously established between a source terminal, connected to one network switching node and a target terminal, connected to another network switching node. In the following example, the source terminal is a mobile terminal (not shown) connected to MSC 110 (FIG. 4) and the target terminal is a land terminal (not shown) connected to CO 140.

The flow of FIG. 10 can be executed in a networking architecture such as presented in FIG. 4, for performing a node telephony operation on a call session between any two network switching nodes (e.g., each node can be an MSC or a CO). The example presented in FIG. 10 addresses a situation wherein the node telephony operation includes terminating an on-going call between a mobile terminal of MSC 110 and a land terminal of CO 140. MSC 110 and CO 140 are two network-switching nodes, which are remote relative to CMS 102. The mobile terminal connected to MSC 110 establishes a conventional call session, directly with the land terminal connected to CO 140, without any mediation of CMS 102.

At a later stage, CMS 102 receives a request to terminate the call. Such a request can be directed to CMS 102 by a monitoring unit within MSC 110, CO 140 or any other network node associated with the call, a monitoring unit which resides in a signaling junction such as STP 108 (e.g., a monitoring sniffer unit), and the like. The monitoring unit detects for example, that the call between MSC 110 and CO 140 is not permissible. When the monitoring unit detects a non-permissible call establishment in progress, then the monitoring unit can transmit a request to the call management system, to prevent that call session from being established. The monitoring unit can transmit the call to the call management system, using special communication channels (e.g., Ethernet, ATM, TCP/IP, X25, and the like), or in a signaling message, while embedding the call parameters within selected SS7 fields.

The following is a partial CIC allocation Table for CO 140.

TABLE 6

| CIC | Channel Connection | Point Code |
|---|---|---|
| 100-299 | 114A | 1 |
| 300-799 | 114B | 1 |
| 800-1500 | 114C | 1 |

The following is a partial CIC allocation Table for MSC 110.

TABLE 7

| CIC | Channel Connection | Point Code |
|---|---|---|
| 100-299 | 114A | 4 |
| 300-799 | 114B | 4 |
| 800-1500 | 114C | 4 |

Initially, the user of the mobile terminal sends a request to MSC 110 for establishing a call (reference 380), where the message includes the mobile identification number (MIN) and dialed digits (DD). The parameters identify the source and the target, which are to be connected. MSC 110 produces an IAM message 382A and directs it to the target terminal network-switching node (e.g., CO 140), via STP 108. STP 108 routes the IAM message 382A to CO 140 as an IAM message 382B, where both IAM messages are substantially identical. The IAM message includes the following parameters:

IAM (MSC-CO)

| OPC | DPC | CLI | DD | CIC_{OPC} |
|---|---|---|---|---|
| 1 | 4 | 654654 | 321321 | 1100 |

CO 140 receives the IAM 382B message, initiates a ring alarm (referenced 384) at the target terminal, generates an acknowledgement message (ACM) 386A and directs it to MSC 110 via STP 108. STP 108 routes the ACM message 386A to MSC 110 as ACM message 386B, where both ACM messages are substantially identical. The ACM message includes the following parameters:

ACM (CO-MSC)

| OPC | DPC | CIC_{OPC} |
|---|---|---|
| 4 | 1 | 1100 |

MSC 110 receives the ACM message 386B, and it initiates a ring back tone 388 at the mobile terminal. At this point the user of the target terminal responds to the ring alarm 384 and sets the terminal off hook (referenced 390). In turn, CO 140 produces an ANM message 392A and directs it to MSC 110, via STP 108. STP 108 routes the ANM message 392A to MSC 110 as an ANM message 392B, where both ANM messages are substantially identical. At this point, a session (reference 394) is established between MSC 110 (CIC 1100) and CO 140 (CIC 1100), over multi-channel connection 114C, without any mediation of CMS 102.

In procedure 420, a request to perform a telephony operation between at least two remote network nodes is received. In the following example, CMS 102 receives a request to terminate the call between MSC 110 and CO 140. According to one aspect of the disclosed technique, the request includes all of the parameters which are required for terminating the call, such as the point codes of the source and target nodes, the CIC on which the session call was established, and the like. Alternatively, the request can include only partial information, where CMS 102 includes the complementary information.

In procedure 422, an originating node identification is determined according to the point code of one of the remote network nodes. According to the information embedded in the request, CMS 102 determines an originating node identification to be the point code of one of the remote network nodes. In the present example, the point code of CO 140 (four) is determined as the originating node identification.

In procedure 424, a destination node identification is determined according to the point code of another one of the remote network nodes. With reference to FIG. 4, CMS 102 determines a destination node identification to be the point code of the other of the remote network nodes. In the present example, the point code of MSC 110 (one) is determined as the destination node identification.

In procedure 426, a signaling message is generated according to the determined originating identification and the destination node identification. With reference to FIG. 4, CMS 102 generates a release message (REL) 396A, which includes the following parameters:

REL (CMS-MSC)

| OPC | DPC | CIC |
|---|---|---|
| 4 | 1 | 1100 |

It is noted that REL 396A does not include any information relating to CMS 102. According to the disclosed technique, CMS 102 produces a signaling message to MSC 110, which appears to be sent from another node (i.e., from CO 140).

Conventional telephony permits a situation where two connected nodes send release messages to each other at the same time. Such a situation can occur when two terminals, each connected to a different node, hang up on each other. Each of the nodes, not yet receiving the release message of the other node, produces a release message and directs it to the other node. Upon receiving a release message from the other node, each of the nodes produces an RLC message and directs it to the other node. In the example set forth in FIG. 10, CMS 102 also generates a REL message 400A, directed to CO 140. REL message 400A includes the following parameters:

REL (CMS-CO)

| OPC | DPC | CIC |
|---|---|---|
| 1 | 4 | 1100 |

It is noted that REL 400A does not include any information relating to CMS 102. CMS 102 produces signaling message 400A to CO 140, where signaling message 400A appears to be sent from MSC 110.

In procedure 428, the signaling message is directed to one of the remote network nodes. With reference to FIG. 4, CMS 102 directs REL message 396A to MSC 110 via STP 108. STP 108 directs REL message 396A to MSC 110, as REL message 396B. It is noted that, since the signaling network is a multiple access network, STP 108 does not have any indication that the REL message 396A was received from a node other than CO 140, unless the message is received from a communication line which is not associated with CO 140.

The example set forth in FIG. 10 involves two messages and hence, CMS 102 performs a similar procedure for REL 400A. CMS 102 directs REL message 400A to CO 140 via STP 108. STP 108 directs REL message 400A to CO 140, as REL message 400B. Again, since the signaling network is a multiple access network, STP 108 does not have any indication that the REL message 400A was received from a node other than MSC 110, unless the message is received from a communication line which is not associated with MSC 110.

In procedure 430, the telephony operation is performed according to the signaling message. The telephony operation is performed without any reference to the node, which initiated it (i.e., CMS 102). With reference to FIGS. 4 and 10, MSC 110 receives REL 396B, disconnect (reference 398) the mobile terminal, and produces an RLC message 404A. RLC message 404A includes the following parameters:

RLC (MSC-CO)

| OPC | DPC | CIC_{OPC} |
|---|---|---|
| 1 | 4 | 1100 |

Since the OPC field of REL 396B included the point code of CO 140, MSC 110 operates under the assumption that CO 140 sent REL 396A, where REL 396A was originally sent by CMS 102. Hence, MSC 110 directs the release confirmation (RLC) message 404A to CO 140, via STP 108. STP 108 directs RLC 404A to CO 140 as RLC 404B.

In the example set forth in FIG. 10, CO 140 receives REL 400B, disconnect (reference 402) the land terminal, and produces an RLC message 406A. RLC message 406A includes the following parameters:

RLC (CO-MSC)

| OPC | DPC | CIC_{OPC} |
|---|---|---|
| 4 | 1 | 1100 |

Since the OPC field of REL 400B included the point code of MSC 110, CO 140 operates under the assumption that MSC 110 sent REL 400A, where REL 400A was originally sent by CMS 102. Hence, CO 140 directs the release confirmation (RLC) message 406A to MSC 110, via STP 108. STP 108 directs RLC 406A to MSC 110 as RLC 406B. Accordingly, each of the network nodes (i.e., MSC 110 and CO 140) releases the system resources (CIC 1100), and the call is disconnected.

Other situations can include a call which is established over a plurality of nodes, for example between a mobile terminal associated with MSC 120 and a mobile terminal associated with MSC 110, through CO 140. The call is directed from MSC 120 to CO 140 via a selected CIC over multi channel connection 144B and from CO 140 to MSC 110 over multi channel connection 114A. In this case, CMS 102 can disconnect the call over any one of the two multi-channel connections involved in the call, or over both of them.

It is noted that the disclosed above technique can be extended to a plurality of telephone functions such as callback, telephone cards, collect calls, and the like.

According to another aspect of the disclosed technique, a first terminal engaged in a call with a second terminal, is notified by a call waiting message from the PPS, that the pre-paid call-credit of the first terminal is approaching zero. The first terminal may choose either to terminate the call or purchase calling time to continue the ongoing call. In case the first terminal chooses to purchase calling time, the first terminal answers the waiting call and establishes a voice link with the PPS, while putting the second terminal on hold. When the call-credit is positive, the first terminal can switch back to the second terminal and resume the original call. The CMS manages the operation of the network node and of the PPS, according to call-credit signals received from the PPS. In the description herein below, the term “topping-up” refers to an action on the part of the user of a pre-paid terminal, in depositing money in the pre-paid account thereof, during a call between the pre-paid terminal and the PPS.

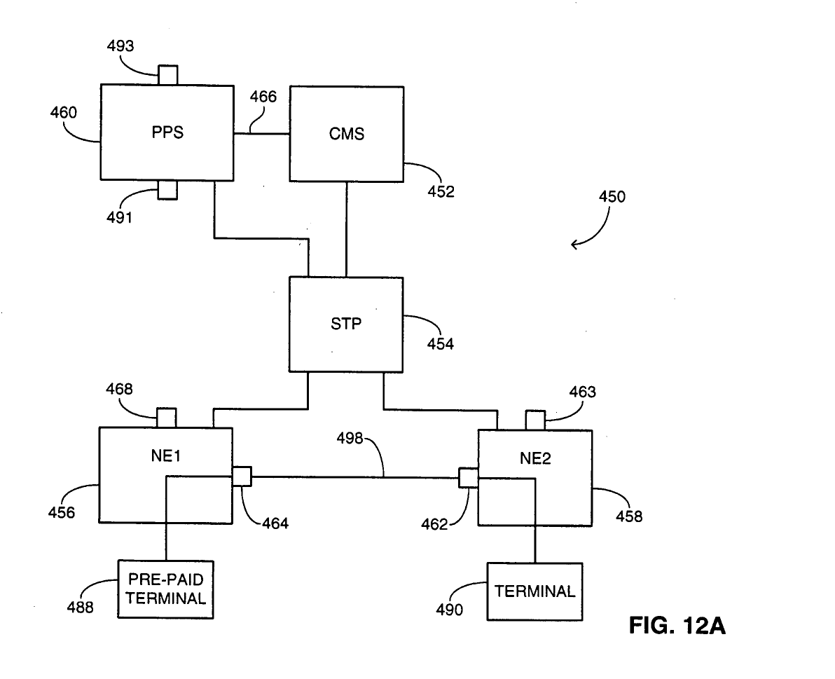

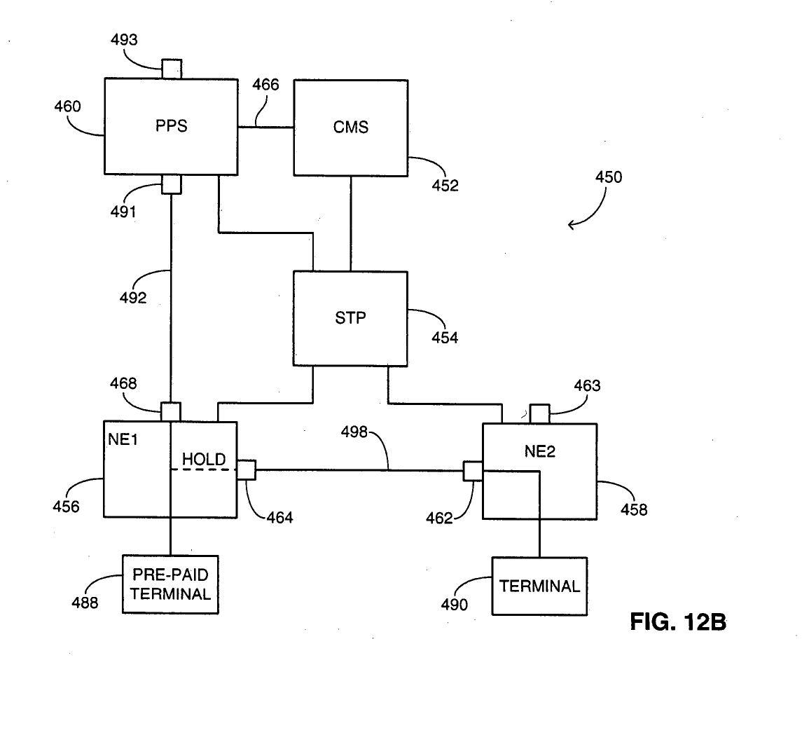

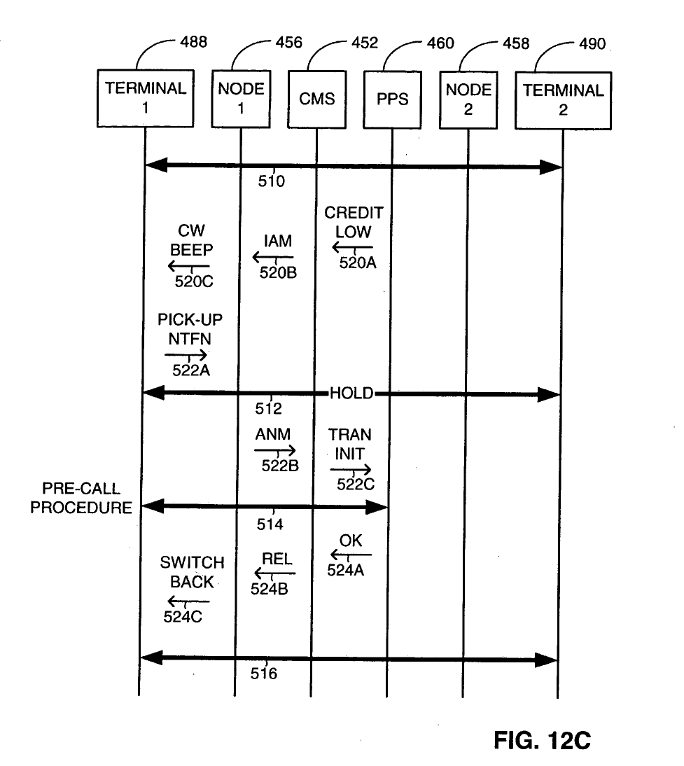

Reference is now made to FIGS. 12A, 12B and 12C. FIG. 12A is a schematic illustration of a system for enabling intervening operations during an ongoing call, generally referenced 450, constructed and operative in accordance with another embodiment of the disclosed technique. FIG. 12B is a schematic illustration of the system of FIG. 12A, in a stage which a terminal purchases calling time from the accounting module of the pre-paid system (PPS) of the system of FIG. 12A, while the call is kept on hold. FIG. 12C is a message flow diagram illustrating some of the stages of the operation of the system of FIG. 12A.

System 450 includes a CMS 452, an STP 454, network nodes 456 and 458, a PPS 460, a pre-paid terminal 488 and a terminal 490. PPS 460 includes ports 491 and 493. Network node 456 includes ports 464 and 468. Network node 458 includes ports 462 and 463. STP 454 is coupled with PPS 460, CMS 452, network node 456 and with network node 458, via respective signaling links, such as signaling system No. 7 (SS7) links. CMS 452 and PPS 460 are coupled together via a communication link 466. In the description herein below, the number 477477 is the MIN of terminal 488, the number 488488 is the MIN of terminal 490, and the number 460460 is a unique number associated with PPS 460.

Each of network nodes 452, 454, 456, 458 and 460 has a unique point code assigned thereto, which serves as identification thereof. The following is a point code Table for the network nodes of FIG. 12A:

TABLE 8

| Network Node | Point Code |
|---|---|
| Network Node 456 | 1 |
| Network Node 458 | 2 |
| Call Management System 452 | 3 |

In the example set forth in FIG. 12A, a telephone call (reference 510 in FIG. 12C) is established between pre-paid terminal 488 and terminal 490, through a connection 498 (i.e., a voice link) between ports 464 and 462. The telephone call is communicated through ports 464 and 462 on a voice level. Accordingly, terminal 488 is coupled to port 464 of network node 456, and terminal 490 is coupled to port 462 of network node 458. The call is managed by CMS 452 via STP 454 on a signaling level, in accordance with the disclosed technique. Since terminal 488 is a pre-paid terminal, PPS 460 constantly monitors the billing aspect of the call, via STP 454.

PPS 460 detects that the call-credit of pre-paid terminal 488 is approaching zero. For example, PPS 460 detects that terminal 488 has only two minutes left on the account. PPS 460 sends a signal 520A to CMS 452, notifying CMS 452 that the call has reached a “low credit” status. CMS 452 sends a signal to PPS 460 to request PPS 460 to allocate CIC 1000 (i.e., voice link 492) for establishing a call between terminal 488 and PPS 460. CMS 452 sends an IAM 520B to network node 456, including the following parameters:

IAM (CMS-NE1)

| OPC | DPC | CLI | DD | CIC |
|---|---|---|---|---|
| 3 | 1 | 460460 | 477477 | 1000 |

In response to IAM 520B, network node 456 allocates CIC 1000. IAM 520B includes also a textual message to notify the user (not shown) of terminal 488, that the pre-paid call-credit has reached a level which is insufficient to continue the call. For example, CMS 452 includes caller ID text or graphics in IAM message 520B which terminal 488 displays (reference 520C in FIG. 12C), such as “two minutes left”, on a display thereof (not shown), or the designation of the PPS. In response to IAM 520B, network node 456 notifies terminal 488 of a waiting call (i.e., from PPS 460), by producing a call waiting beep 520C, and the textual message which is attached to IAM 520B.

It is noted that IAM 520B is delivered using STP 454. However, since STP 454 essentially mirrors the message from CMS 452 and transfers this message on to network node 456, the STP 454 shall be ignored in the description herein below, in connection with FIGS. 12A, 12B, 12C, 13A, 13B, 14A and 14B. It is further noted that a series of respective IAM′, ACM and ACM′ messages follow each IAM message. Similarly, a respective RLC message follows each REL message. However, in order to simplify the description herein below, the IAM′, ACM, ACM′ and RLC messages are omitted from FIGS. 12C, 13B and 14B. Network node 456 receives IAM 520C and delivers a call-waiting notification 520C to terminal 488.

In response to message 520C, the user of terminal 488 can top-up the pre-paid account thereof, in order to continue the call. For this purpose, terminal 488 sends a pick-up notification message 522A to network node 456 (i.e., the user answers the waiting call, for example by pressing the send button on terminal 488), thereby putting terminal 490 on hold (reference 512 in FIG. 12C).

In response to message 522A, network node 456 sends an ANM 522B to CMS 452, to notify CMS 452 that terminal 488 has accepted the waiting call from PPS 460. CMS 452 sends a pre-paid user transaction initiation command 522C over CIC 1000 (i.e., connection 492) to PPS 460 via communication link 466. Thus, the call between terminal 488 and PPS 460 is established through a connection 492 on CIC 1000 at ports 468 and 491 (reference 514). At this point the user of terminal 488 can top-up the pre-paid account. It is noted that PPS 460 may pause charging the user of terminal 488 for her original call, while the user is topping-up.

When PPS 460 detects that the call-credit of the pre-paid account is positive, PPS 460 sends an OK signal 524A to CMS 452. In response to OK signal 524A, CMS 452 sends a release message REL 526A 524B to network node 456. Network node 456 dis-allocates CIC 1000. CMS 452 also sends a signal to PPS 460 via communication link 466 to request PPS 460 to dis-allocate CIC 1000. In this manner, the call which was established between network node 456 and PPS 460 (i.e., connection 492) is disconnected. Network node 456 switches terminal 488 back to terminal 490 (reference 524C) and the user of terminal 488 resumes the call which was on hold (reference 516 in FIG. 12C). Alternatively, the user of terminal 488 returns back to terminal 490, by communicating with the user interface (not shown) of terminal 488, following an announcement by network node 456 (e.g., by pressing the send button). Alternatively, in response to message 520C, the user of terminal 488 may decide not to top-up the pre-paid account and terminate the ongoing call with terminal 490.

According to a further aspect of the disclosed technique, a pre-paid call-credit of a first terminal is checked before a first call between the first terminal and a second terminal is established. In case the PPS detects that the call-credit is insufficient for placing the first call, the CMS establishes a second call between the first terminal and the PPS, according to a signal received from the PPS, to notify the user of the first terminal that the call-credit is insufficient for placing the first call. The second call is established through a first connection between the PPS and a second network node associated with the second terminal, and a second connection between the second network node and a first network node associated with the first terminal. When the PPS detects that the call-credit is positive, the PPS requests the CMS to terminate the second call, and the first terminal is allowed to proceed and place the requested first call.

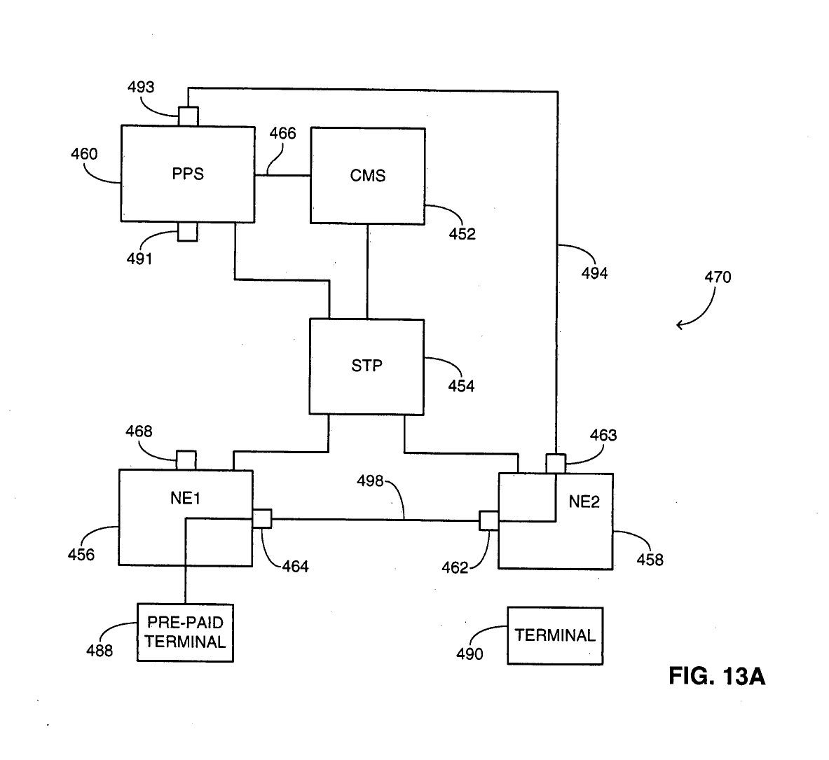

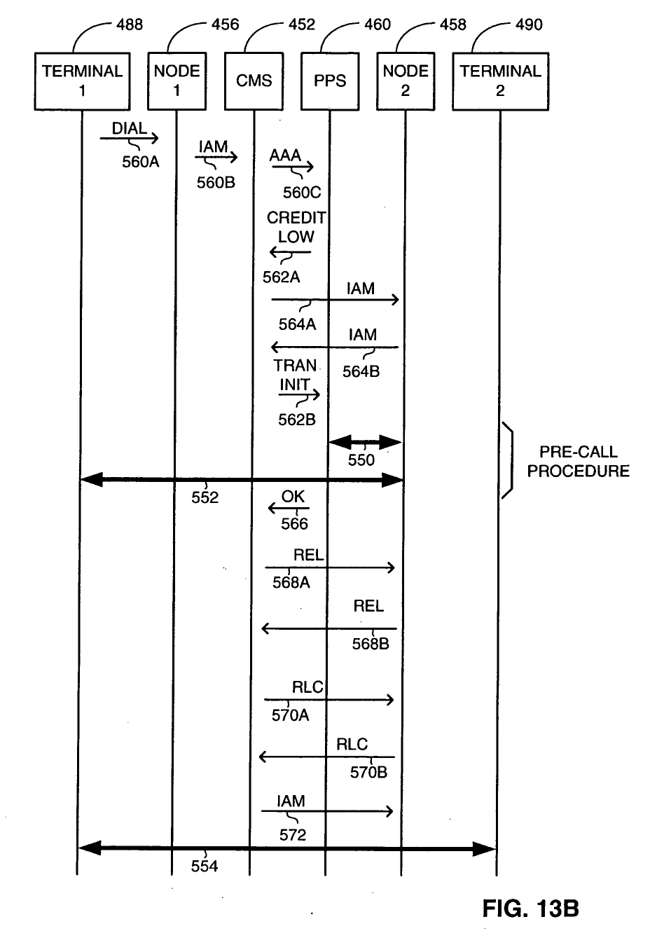

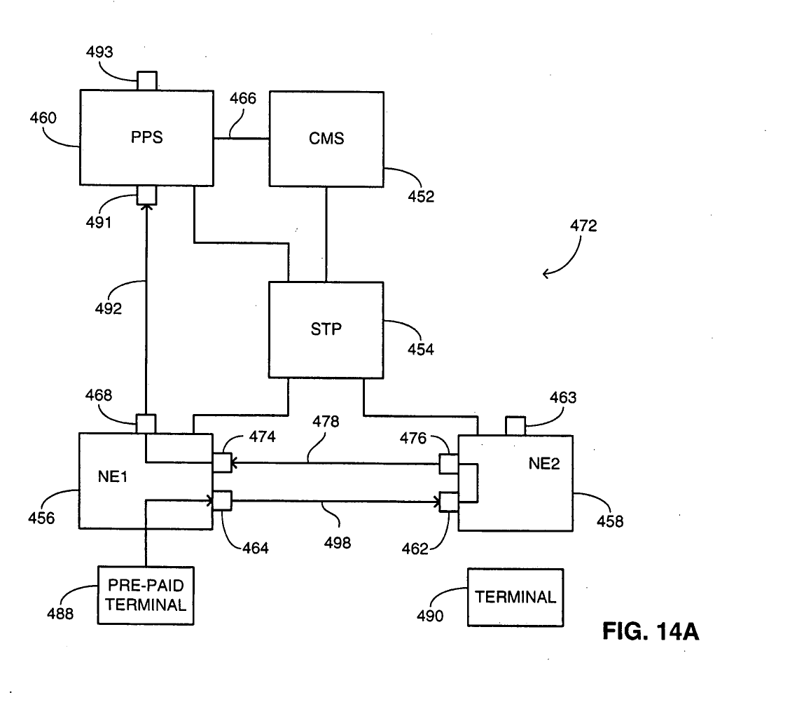

Reference is now made to FIGS. 13A and 13B. FIG. 13A is a schematic illustration of a system, generally referenced 470, for establishing a second call between a pre-paid system and a pre-paid terminal, before the pre-paid terminal is allowed to place a first call with another terminal, constructed and operative in accordance with a further embodiment of the disclosed technique. FIG. 13B a schematic illustration of a message flow diagram for operating the system of FIG. 13A.

Pre-paid terminal 488 dials the number of terminal 490 (reference 560A), wherein terminal 488 connects to network node 456 and provides the MIN thereof, as well as the MIN of terminal 490. Network node 456 sends an IAM 560B to CMS 452, having the following parameters:

IAM (NE1-CMS)

| OPC | DPC | CLI | DD | CIC |
|---|---|---|---|---|
| 1 | 3 | 477477 | 488488 | 500 |

In this manner, network node 456 notifies CMS 452 that network node 456 has allocated CIC 500 (i.e., connection 498) for a call between terminals 488 and 490. According to CLI 477477 (i.e., the MIN of terminal 488), CMS determines that terminal 488 is a pre-paid terminal. Hence, CMS 452 sends an authorization, and authentication and accounting (AAA) message 560C to PPS 460, requesting PPS 460 to check the pre-paid account of terminal 488. PPS 460 detects that the call-credit of the pre-paid account of terminal 488 is low (i.e., approaching zero), and PPS 460 notifies CMS 452 by sending a signal 562A to CMS 452, via communication link 466. In order to establish a call between terminal 488 and PPS 460, CMS 452 sends an IAM 564A to network node 458 having the following parameters:

IAM (CMS-NE2)

| OPC | DPC | CLI | DDDD | CIC |
|---|---|---|---|---|
| 3 | 2 | 477477 | 460460 | 500 |

In response to IAM 564A, network node 458 allocates CIC 500. Thus, connection 498 on CIC 500 is established between network nodes 456 and 458, at ports 464 and 462, respectively. Network node 458 sends an IAM 564B to CMS 452 having the following parameters:

IAM (NE2-CMS)

| OPC | DPC | CLI | DD | CIC |
|---|---|---|---|---|
| 2 | 3 | 477477 | 460460 | 700 |

In this manner network node 458 notifies CMS 452, that network node 458 has allocated CIC 700 (i.e., voice link 494) associated with CIC 500.

It is noted that the MIN of each terminal is associated with a predetermined network node, wherein each network node is identified by a unique point code (Table 8). In a conventional communication system (not shown), MIN 477477 of terminal 488 is associated with network node 456 and MIN 488488 of terminal 490 is associated with network node 458. Each network node includes a look-up Table (not shown), which associates each MIN with the corresponding network node (i.e., point code). However, according to the disclosed technique, the look-up Table in each of network nodes 456 and 458, associates each of MIN 477477, 488488 and 460460 with CMS 452 (i.e., point code 3). Thus, for example, when network node 458 receives IAM 564A carrying a DD 460460, according to the look-up Table stored therein, network node 458 selects point code 3 as the value of the DPC in IAM 564B.

CMS 452 sends a pre-paid user transaction initiation command 562B, via communication link 466 to PPS 460, requesting PPS 460 to allocate CIC 700. In this manner, network node 458 connects to PPS 460 over CIC 700 at ports 463 and 493, and a call (references 550 and 552) is established between terminal 488 and PPS 460 over CICs 500 and 700 (i.e., via connections 498 and 494, at ports 464, 462, 463 and 493). PPS 460 plays an announcement for terminal 488, for example, that due to a low pre-paid call-credit, the requested call is denied. The user of terminal 488 can top-up the pre-paid account, in order to place the call. Alternatively, the user may decide not to top-up and cancel the requested call. When PPS 460 detects that the call-credit is positive, PPS 460 sends an OK signal 566 to CMS 452. In response to OK signal 566, CMS 452 sends a REL message 568A to network node 458, whereby network node 458 dis-allocates CIC 700 (i.e., connection 494) on port 463. CMS 452 also sends a signal to PPS 460 via communication link 466, to request PPS 460 to dis-allocate CIC 700. In this manner, connection 494 between network node 458 and PPS 460 over CIC 700 is disconnected.

Network node 458 sends a REL message 568B to CMS 452 to notify CMS 452 that network node 458 has dis-allocated CIC 500 (i.e., connection 498). CMS 452 sends an RLC message 570A to network node 458 as an acknowledgement of REL message 568B, and network node 458 sends an RLC message 570B to CMS 452 as an acknowledgement of REL message 568A. At this moment, all the connections which were established subsequent to IAM 560B are disconnected, and network node 456 has allocated only CIC 500.

CMS 452 sends an IAM 572 to network node 458 having the following parameters:

IAM (CMS-NE2)

| OPC | DPC | CLI | DD | CIC |
|---|---|---|---|---|
| 3 | 2 | 477477 | 488488 | 500 |

whereby terminals 488 and 490 are connected (reference 554 in FIG. 13B), over CIC 500 (i.e., connection 498) at ports 464 and 462.

According to another aspect of the disclosed technique, the pre-paid call-credit of a first terminal is checked before a first call between the first terminal and a second terminal is established. In case the PPS detects that the call-credit is insufficient for placing the first call, the CMS establishes a second call between the first terminal and the PPS, according to a signal received from the PPS, to notify the user of the first terminal that the call-credit is insufficient for placing the first call. The second call is established through a first connection between the PPS and a first network node associated with the first terminal, a second connection between the first network node and a second network node associated with the second terminal, and a third connection between the second network node and the first network node. When the PPS detects that the call-credit is positive, the PPS requests the CMS to terminate the second call, and the first terminal is allowed to proceed and place the requested first call.

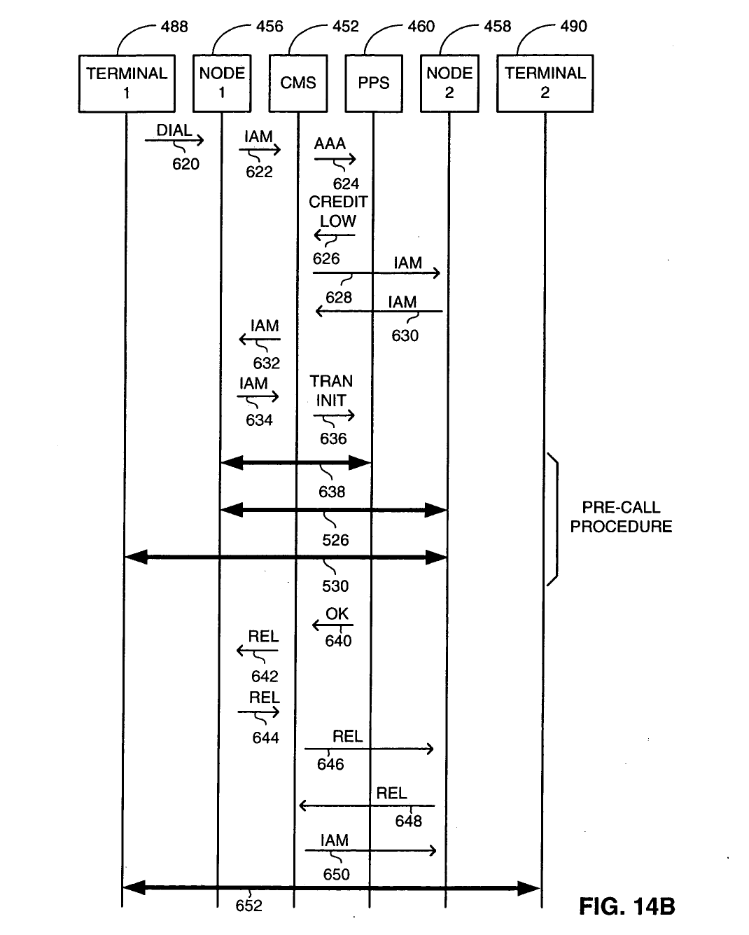

Reference is now made to FIGS. 14A and 14B. FIG. 14A is a schematic illustration of a system, generally referenced 472, for establishing a second call between a pre-paid system and a pre-paid terminal, before the pre-paid terminal is allowed to place a first call with another terminal, constructed and operative in accordance with another embodiment of the disclosed technique. FIG. 14B is a schematic illustration of a message flow diagram for operating the system of FIG. 14A.

Network node 456 includes ports 464 and 474, and network node 458 includes ports 462 and 476. System 472 is similar to system 470 (FIG. 13A), except that terminal 488 is connected to PPS 460 through a loop via network nodes 456 and 458, and not through connection 494. Terminal 456 sends a dial message 620 to network node 456, whose CLI is the MIN of terminal 488, and whose DD is the MIN of terminal 490. In response to dial message 620 network node 456 sends an IAM 622 to CMS 452, to notify CMS 452 that network node 456 has allocated CIC 500 (i.e., connection 498). The CLI of IAM 622 is the MIN of terminal 488 and the DD of IAM 622 is the MIN of terminal 490.

CMS 452 determines according to the MIN of terminal 488, that terminal 488 is a per-paid terminal, and hence CMS 452 sends an AAA message 624 to PPS 460 requesting PPS 460 to check the pre-paid call-credit of terminal 488. PPS 460 detects that the call-credit is insufficient to place the call, and PPS 460 notifies CMS 452 by sending a signal 626 to CMS 452 via communication link 466.

CMS 452 sends an IAM 628 to network node 458, requesting network node 458 to allocate CIC 500. The CLI of IAM 628 is the MIN of terminal 488 and the DD of IAM 628 is a unique number associated with PPS 460. In this manner, networks nodes 456 and 458 are connected on CIC 500 at ports 464 and 462, respectively (i.e., via connection 498). In response to IAM 628, network node 458 sends an IAM 630 to CMS 452, to notify CMS 452 that network node 458 has allocated CIC 600 (i.e., connection 478) associated with CIC 500. The CLI of IAM 630 is the MIN of terminal 488 and the DD of IAM 630 is the unique number of PPS 460.

CMS 452 sends an IAM 632 to network node 456 to allocate CIC 600. The CLI of IAM 632 is the MIN of terminal 488 and the DD of IAM 632 is the unique number of PPS 460. In this manner, network nodes 456 and 458 are connected on CICs 500 and 600 at ports 464, 462, 474 and 476 (i.e., via connections 498 and 478). In response to IAM 632, network node 456 sends an IAM 634 to CMS 452 that network node 456 has allocated CIC 1000 (i.e., connection 492) associated with CIC 600 (i.e., connection 478). CMS 452 sends a pre-paid user transaction initiation command 636 to PPS 460 via communication link 466, requesting PPS 460 to allocate CIC 1000. In this manner, a call (references 638, 526 and 530 in FIG. 14B) is established between terminal 488 and PPS 460 on CICs 500, 600 and 1000, on ports 464, 462, 476, 474, 468 and 491 (i.e., via connections 498, 478 and 492). At this point network nodes 456 and 458, CMS 452, PPS 460 and interconnecting STPs (not shown), transmit ACM messages (not shown) to the respective network nodes, corresponding to the respective IAMs.

Once call 638 is established, PPS 460 plays an announcement for terminal 488, for example, that due to a low pre-paid call-credit, the requested call is denied. The user of terminal 488 can top-up the pre-paid account, in order to place the call. When PPS 460 detects that the call-credit is positive, PPS 460 sends an OK signal 640 to CMS 452. Alternatively, the user may decide not to top-up the pre-paid account and cancel the requested call.

In response to OK signal 640, CMS 452 sends a REL message 642 to network node 456 to dis-allocate CIC 1000. CMS 452 also sends a signal to PPS 460 via communication link 466, requesting PPS 460 to dis-allocate CIC 1000. In this manner, connection 492 between network node 456 and PPS 460 is disconnected. In response to REL message 642, network node 456 sends a REL message 644 to CMS 452 notifying CMS 452 that network node 456 has dis-allocated CIC 600 (i.e., connection 478).

CMS 452 sends a REL message 646 to network node 458 requesting network node 458 to dis-allocate CIC 600. In this manner, connection 478 between network nodes 456 and 458 is disconnected. In response to REL message 646, network node 458 sends a REL message 648 to CMS 452, notifying CMS 452 that network node 458 has dis-allocated CIC 500 (i.e., connection 498). At this moment, all the connections which were established subsequent to IAM 622 are disconnected, and network node 456 has allocated only CIC 500. CMS 452 sends an IAM 650 to network node 458 to allocate CIC 500, whereby terminals 488 and 490 are connected (reference 652 in FIG. 14B), over CIC 500 at ports 464 and 462, and wherein IAM 650 is similar to IAM 572 (FIG. 13B).

It is noted that the user of a first terminal which is engaged in a call with a second terminal, can ignore the call waiting beep and the message from the PPS, that the pre-paid call-credit of the first terminal is approaching zero, and continue the call with the second terminal, despite the low call-credit. According to a further aspect of the disclosed technique, the CMS manages the operation of the PPS, a first network node associated with the first terminal, and a second network node associated with the second terminal, in order to disconnect the call, and to send an explanatory message to the first terminal for disconnecting the call.

The CMS disconnects the second terminal from the second network node, and establishes a call between the first terminal and the PPS, to enable the PPS to play the explanatory message for the first terminal. The CMS disconnects the second terminal from the second network node, by sending a REL message to the second network node to dis-allocate the CIC over which the call between the first terminal and the second terminal is present. At this moment, the second terminal is disconnected from the second network node, while the first terminal remains connected to the first network node at the same port and over the same CIC.

The CMS establishes the call between the first terminal and the PPS over this CIC and additional CICs, either as described herein above in connection with FIGS. 13A and 13B (i.e., via connections 498 and 494), or as described herein above in connection with FIGS. 14A and 14B (i.e., via connections 498, 478 and 492). The CMS sends a signal to the PPS to request the PPS to deliver the explanatory message to the first terminal.

Once the explanatory message from the PPS to the first terminal is complete, the CMS disconnects the connections which were made for establishing the call between the first terminal and the PPS, according to a signal received from the PPS. The CMS sends appropriate REL messages to the first network node and to the second network node, to disconnect these connections and to disconnect the first terminal from the first network node, thereby terminating the call.

It is noted that the CMS, the STP and the PPS perform substantially the same scenario as that described in connection with each of FIGS. 12C, 13B and 14B, also when both the calling terminal and the called terminal are associated with the same network node. However, in these cases, the connection between the network node and the PPS is a direct one, and the CMS instructs the network node how to manipulate the two ports at which the two terminals are connected, or attempt to connect to.

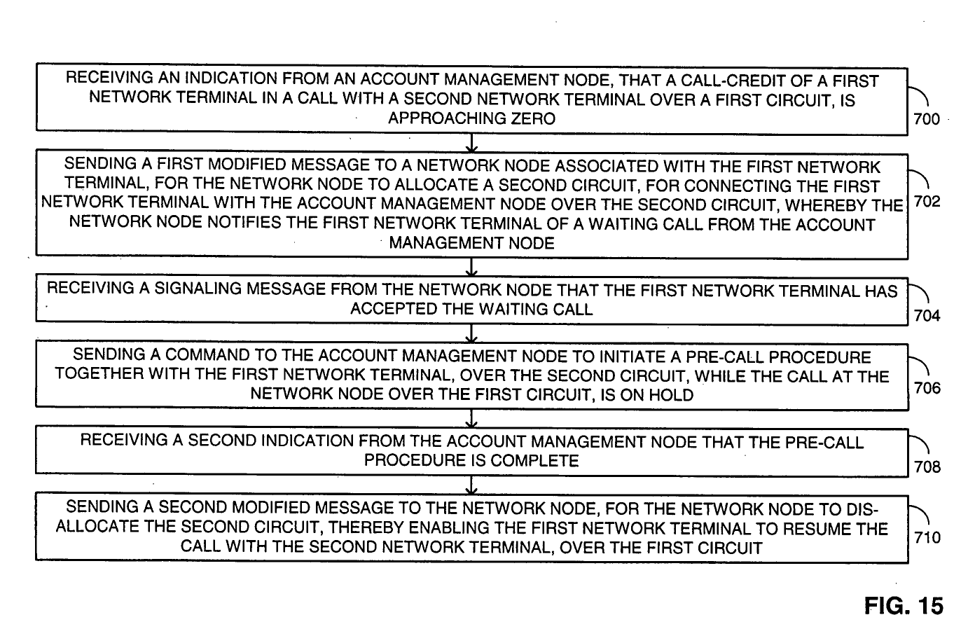

Reference is now made to FIG. 15, which is a schematic illustration of a method for operating the system of FIG. 12A, operative in accordance with a further embodiment of the disclosed technique. In procedure 700, a first indication is received from an account management node, that a call-credit of a first network terminal connected with a second network terminal over a first circuit (i.e., a first voice link), is approaching zero. With reference to FIGS. 12A and 12C, PPS 460 constantly monitors the call between terminals 488 and 490 over CIC 500 (i.e., voice link 498), via STP 454, for billing purposes. When PPS 460 detects that the pre-paid call-credit of terminal 488 is approaching zero, PPS 460 notifies CMS 452 by sending a message 520A to CMS 452, via communication link 466.

In procedure 702, a first modified message is sent to a network node associated with the first network terminal, for the network node to allocate a second circuit, for connecting the first network terminal with the account management node over the second circuit, whereby the first network node notifies the first network terminal of a waiting call from the account management node. With reference to FIGS. 12B and 12C, CMS 452 sends IAM 520B to network node 456 via STP 454, requesting network node 456 to allocate CIC 1000 (i.e., connection 492), for connecting terminal 488 with PPS 460 over CIC 1000. In response to IAM 520B, network node 456 sends a call waiting beep and a textual or graphical call waiting caller ID respective of PPS 460, to the user interface of terminal 488, to notify the user of terminal 488 that the call-credit is low, and that PPS 460 is calling terminal 488.

The user of terminal 488 can answer call waiting message 520C, in order to top-up the pre-paid account. Alternatively, the user can refrain from topping-up the pre-paid account and instead terminate the call with terminal 490. When the user answers call waiting message 520C (e.g., by pressing the send button on the user interface), terminal 488 sends pick-up notification message 522A to network node 456. At this point, terminal 490 is put on hold (reference 512).

In procedure 704, a signaling message is received from the network node, that the first network terminal has accepted the waiting call. With reference to FIG. 12C, network node 456 sends ANM 522B to CMS 452, that terminal 488 has answered the waiting call, and that network node 456 has allocated CIC 1000 (i.e., connection 492).

In procedure 706, a command is sent to the account management node to initiate a pre-call procedure together with the first network terminal, over the second circuit, while the call at the second network node over the first circuit, is on hold. With reference to FIGS. 12B and 12C, CMS 452 sends pre-paid user transaction initiation command 522C to PPS 460 via communication link 466, to request PPS 460 to initiate a pre-call procedure together with terminal 488 over CIC 1000. In this manner, a call is established between terminal 488 and PPS 460 over connection 492 (reference 514), while the call at network node 456 is on hold. At this point, the user of terminal 488 can negotiate with PPS 460 and top-up the pre-paid account, in order to continue the call. It is noted that the pre-call procedure can include an announcement from PPS 460 to terminal 488, for the user of terminal 488 (e.g., to inform him that credit is low and that top-up the pre-paid account is due).

In procedure 708, a second indication is received from the account management node, that the pre-call procedure is complete. With reference to FIG. 12C, when PPS 460 determines that the call-credit of the pre-paid account is positive, PPS 460 sends OK signal 524A to CMS 452.

In procedure 710, a second modified message is sent to the network node, for the network node to dis-allocate the second circuit, thereby enabling the first network terminal to resume the call with the second network terminal, over the first circuit. With reference to FIG. 12C, CMS 452 sends REL message 524B to network node 456 via STP 454, to request network node 456 to dis-allocate CIC 1000. CMS 452 also sends a signal to PPS 460 via communication link 466, to request PPS 460 to dis-allocate CIC 1000. Thus, terminal 488 is disconnected from PPS 460.

At this point, network node 456 switches terminal 488 back to terminal 490, and the call between terminals 488 and 490 over CIC 500 (i.e., voice link 498) is resumed. Alternatively, network node 456 sends a switch back message 524C to terminal 488, requesting terminal 488 to manually switch back to terminal 490 (e.g., by requesting the user to press the send button on the user interface of terminal 488). It is noted that the user can refrain from switching back to terminal 490, and simply terminate the call by pressing for example, the end button on the user interface.

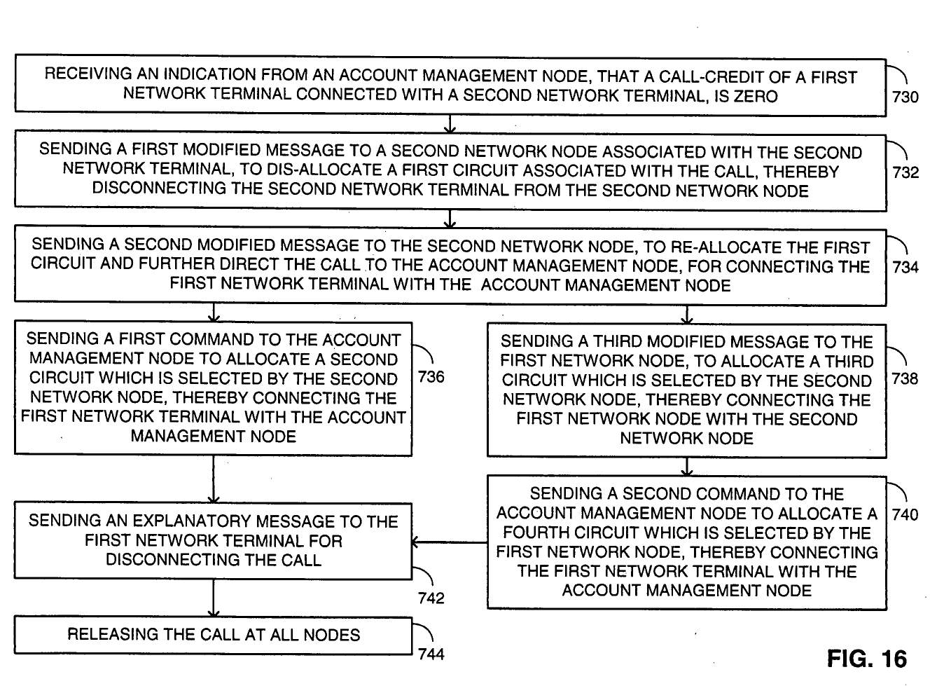

Reference is now made to FIG. 16, which is a schematic illustration of a method for operating the system of FIG. 12A, operative in accordance with another embodiment of the disclosed technique. In procedure 730, a first indication is received from an account management node, that a call-credit of a first network terminal connected with a second network terminal, is zero.

With reference to FIG. 12A, a pre-paid call is ongoing between terminals 488 and 490 over CIC 500 (i.e., connection 498). However, the call-credit in the pre-paid account of terminal 488 (i.e., a pre-paid terminal), is insufficient for maintaining the call. The user of terminal 488 was previously notified that the call-credit was low (e.g., by receiving call waiting message 520C in FIG. 12C). However, the user performed nor topped-up the pre-paid account, neither terminated the call. As a result, PPS 460 sends a signal to CMS 452 via communication link 466, to notify CMS 452 that the call-credit is zero.

In procedure 732, a first modified message is sent to a second network node associated with the second network terminal, to dis-allocate a first circuit associated with the call, thereby disconnecting the second network terminal from the second network node. With reference to either of FIG. 13A or 14A, CMS 452 sends a REL message (not shown) to network node 458, to dis-allocate CIC 500 (i.e., connection 498). As a result, terminal 490 is disconnected from network node 458.

In procedure 734, a second modified message is sent to the second network node, to re-allocate the first circuit and further direct the call to the account management node, for connecting the first network terminal with the account management node. With reference to either of FIG. 13A or 14A, CMS 452 sends an IAM (not shown) to network node 458 to re-allocate CIC 500 (i.e., connection 498) for connecting terminal 488 with PPS 460.

The method can proceed either to procedure 736, wherein the first network terminal is connected with the PPS according to FIG. 13A, or to procedures 738 and 740, wherein the first network terminal is connected with the PPS according to FIG. 14A. If the connection is made according to FIG. 13A, then procedure 736 is followed by procedures 742 and 744. If the connection is made according to FIG. 14A, then procedure 740 is followed by procedures 742 and 744.

In procedure 736, a first command is sent to the account management node to allocate a second circuit which is selected by the second network node, thereby connecting the first network terminal with the account management node. With reference to FIG. 13A, in response to the IAM received from CMS 452 (procedure 734), network node 458 sends another IAM to CMS 452, notifying CMS 452 that network node 458 has allocated CIC 700 (i.e., connection 494) associated with CIC 500 (i.e., connection 498). In response to the IAM received from network node 458, CMS 452 sends a signal to PPS 460 via communication link 466, requesting PPS 460 to allocate CIC 700. In this manner, a call is established between terminal 488 and PPS 460 over CICs 500 and 700 (i.e., connections 498 and 494, respectively).

In procedure 738, a third modified message is sent to the first network node, to allocate a third circuit which is selected by the second network node, thereby connecting the first network node with the second network node. With reference to FIG. 14A, in response to the IAM received from CMS 452 (procedure 734), network node 458 sends another IAM to CMS 452, notifying CMS 452 that network node 458 has allocated CIC 600 (i.e., connection 478) associated with CIC 500 (i.e., connection 498). In response to the IAM received from network node 458, CMS 452 sends an IAM (not shown) to network node 456, requesting network node 456 to allocate CIC 600. In this manner, network nodes 456 and 458 are connected via CICs 500 and 600 (i.e., connections 498 and 478, respectively). Furthermore, network node 456 sends an IAM (not shown) to CMS 452, that network node 456 has allocated CIC 1000 (i.e., connection 492) associated with CIC 600 (i.e., connection 478).

In procedure 740, a second command is sent to the account management node to allocate a fourth circuit which is selected by the first network node, thereby connecting the first network terminal with the account management node. With reference to FIG. 14A, in response to the IAM received from network node 456, CMS 452 sends a signal to PPS 460 via communication link 466, requesting PPS 460 to allocate CIC 1000. In this manner, a call is established between terminal 488 and PPS 460 over CICs 500, 600 and 1000 (i.e., connections 498, 478 and 492, respectively).

In procedure 742, an explanatory message is sent to the first network node for disconnecting the call. With reference to FIG. 13A, PPS 460 sends a message (either audio, visual or both) to terminal 488, notifying the user of terminal 488 that due to a low call-credit in the pre-paid account, the call has been disconnected. CMS 452, then sends a REL message (not shown) to network node 456 to dis-allocate CIC 500, thereby disconnecting terminal 488 from network node 456 (procedure 744). According to another aspect of the disclosed technique, instead of procedure 736, procedures 742 and 744 are performed after performing procedure 734, and procedures 738 and 740 are performed after performing procedure 744.

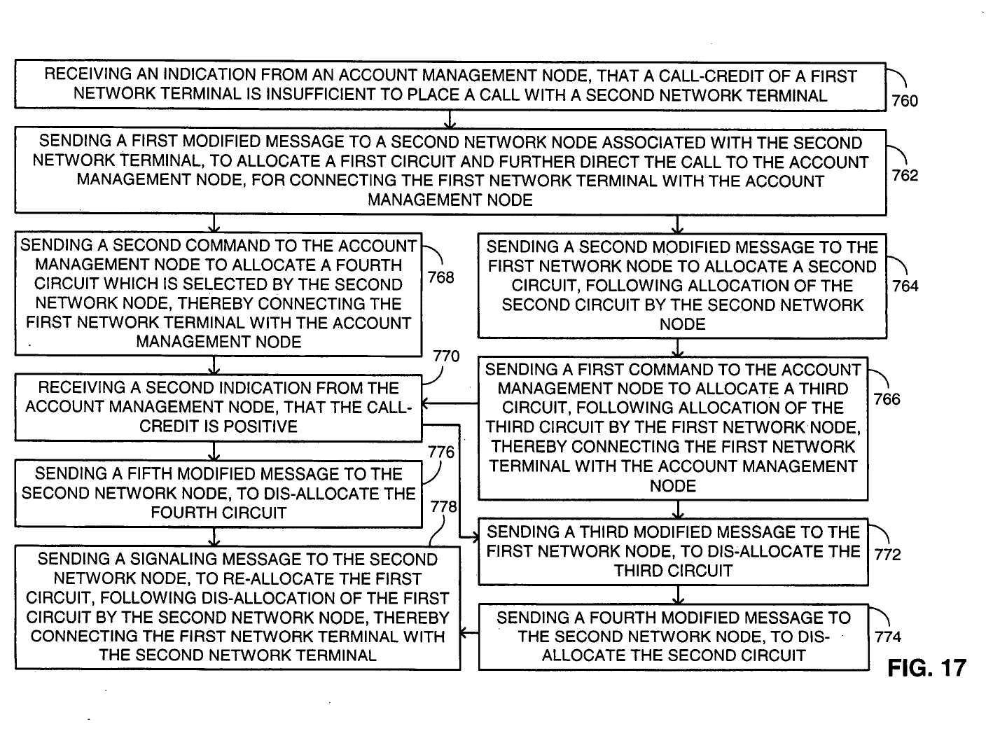

Reference is now made to FIG. 17, which is a schematic illustration of a method for operating the system of either of FIG. 13A or 14A, operative in accordance with a further embodiment of the disclosed technique. In procedure 760, a first indication is received from an account management node, that a call-credit of a first network terminal is insufficient to place a call with a second network terminal.

With reference to either of FIG. 13A or 14A, the user of terminal 488 dials the MIN of terminal 490 (either of references 560A or 620, in FIGS. 13B and 14B, respectively). Network node 456 sends either of IAMs 560B or 622 (FIG. 13B or 14B, respectively), to CMS 452, to notify CMS 452 that network node 456 has allocated CIC 500 (i.e., connection 498). CMS 452 constantly monitors the operation of network nodes 456 and 458, respective of pre-paid terminals which are connected to network nodes 456 and 458. Since terminal 488 is a pre-paid terminal, CMS 452 requests PPS 460 to check the call-credit of terminal 488 (either of AAA messages 560C or 624, in FIGS. 13B and 14B, respectively). PPS 460 detects that the call-credit is insufficient for terminal 488 to place the requested call, and notifies CMS 452 by sending a signal (either of references 562A or 626, in FIG. 13B or 14B, respectively) to CMS 452.

In procedure 762, a first modified message is sent to a second network node associated with the second network terminal, to allocate a first circuit and further direct the call to the account management node, for connecting the first network terminal with the account management node. With reference to FIGS. 13B and 14B, CMS 452 sends either of IAMs 564A or 628, respectively, to network node 458 to allocate CIC 500 (i.e., connection 498).

The method can proceed either to procedures 764 and 766, wherein the first network terminal is connected with the PPS according to FIG. 14A, or to procedure 768, wherein the first network terminal is connected with the PPS according to FIG. 13A. Procedure 766 is followed by procedures 770, 772, 774 and 778, wherein the first network terminal is connected with the second network terminal, subsequent to a pre-call procedure, via a connection between the first network terminal and the PPS, according to FIG. 14A. Procedure 768 is followed by procedures 770, 776 and 778, wherein the first network terminal is connected with the second network terminal, subsequent to a pre-call procedure, via a connection between the first network terminal and the PPS, according to FIG. 13A.

In procedure 764, a second modified message is sent to the first network node to allocate a second circuit, following allocation of the second circuit by the second network node. With reference to FIGS. 14A and 14B, in response to IAM 628 received from CMS 452 (procedure 762), network node 458 sends IAM 630 to CMS 452, to notify CMS 452 that network node 458 has allocated CIC 600 (i.e., connection 478), associated with CIC 500 (i.e., connection 498). In response to IAM 630, CMS 452 sends IAM 632 to network node 456, to request network node 456 to allocate CIC 600.

In procedure 766, a first command is sent to the account management node to allocate a third circuit, following allocation of the third circuit by the first network node, thereby connecting the first network terminal with the account management node. With reference to FIGS. 14A and 14B, in response to IAM 632 received from CMS 452 (procedure 772), network node 456 sends IAM 634 to CMS 452, to notify CMS 452 that network node 456 has allocated CIC 1000 (i.e., connection 492) associated with CIC 600 (i.e., connection 478). In response to IAM 634, CMS 452 sends a signal to PPS 460 via communication link 466, to request PPS 460 to allocate CIC 1000, whereby a call is established between terminal 488 and PPS 460, over CICs 500, 600 and 1000 (i.e., connections 498, 478 and 1000, respectively).

In procedure 768, a second command is sent to the account management node to allocate a fourth circuit which is selected by the second network node, thereby connecting the first network terminal with the account management node. With reference to FIGS. 13A and 13B, in response to IAM 564A received from CMS 452 (procedure 762), network node 458 sends IAM 564B to CMS 452, to notify CMS 452 that network node 458 has allocated CIC 700 (i.e., connection 494) associated with CIC 500. In response to IAM 564B, CMS 452 sends a signal via communication link 466 to PPS 460, to request PPS 460 to allocate CIC 700. In this manner, a call is established between terminal 488 and PPS 460 over CICs 500 and 700 (i.e., connections 498 and 494, respectively, and references 550 and 552 in FIG. 13B). The user of terminal 488 negotiates with PPS 460 to top-up the pre-paid account in order to allow placing of the requested call.

In procedure 770, a second indication is received from the account management node, that the call-credit is positive. With reference to FIG. 13B, PPS 460 sends OK signal 566 to CMS 452 via communication link 466, to notify CMS 452 that the call-credit is positive.

In procedure 772, a third modified message is sent to the first network node, to dis-allocate the third circuit. With reference to FIGS. 14A and 14B, in response to OK signal 640 from PPS 460, CMS 452 sends REL 642 to network node 456, to dis-allocate CIC 1000 (i.e., connection 492). Network node 456 sends IAM 644 to CMS 452, to notify CMS 452 that network node 456 has dis-allocated CIC 1000.

In procedure 774, a fourth modified message is sent to the second network node, to dis-allocate the second circuit. CMS 452 sends REL 646 to network node 458 to request network node 458 to dis-allocate CIC 600 (i.e., connection 478). In response to REL message 646, network node 458 sends REL message 648 to CMS 452, to notify CMS 452 that network node 458 has dis-allocated CIC 500 (i.e., connection 498).

In procedure 776, a fifth modified message is sent to the second network node, to dis-allocate the fourth circuit. With reference to FIG. 13B, CMS 452 sends REL 568A to network node 458 to dis-allocate CIC 700 (i.e., connection 494).

In procedure 778, a signaling message is sent to the second network node, to re-allocate the first circuit, following dis-allocation of the first circuit by the second network node, thereby connecting the first network terminal with the second network terminal. With reference to FIG. 13B, in response to REL message 568A received from CMS 452, network node 458 sends REL 568B to CMS 452, to notify CMS 452 that network node 458 has dis-allocated CIC 500 (i.e., connection 498). In response to REL 568B, CMS 452 sends IAM 572 to network node 458 to re-allocate CIC 500, whereby the requested call between terminals 488 and 490 is established via connection 498. Alternatively, in response to REL 648 (FIG. 14B), CMS 452 sends IAM 650 to network node 458 to re-allocate CIC 500, whereby the requested call between terminals 488 and 490 is established via connection 498.

It will be appreciated by persons skilled in the art that the disclosed technique is not limited to what has been particularly shown and described hereinabove. Rather the scope of the disclosed technique is defined only by the claims, which follow.

1. Network architecture for enabling a first network terminal connected in a call with a second network terminal via a first circuit, to purchase calling time during the call, the network architecture comprising:
a first network node connected to said first network terminal;
a second network node connected to said second network terminal;
an account management node connected to said first network node, said account management node managing a pre-paid account associated with said first network terminal; and
a call management node connected to said first network node via a signaling link, to said account management node via a communication link, and to said second network node, said call management node connecting said first network terminal with said account management node over a second circuit, while said second network terminal is on hold, whereby said first network terminal purchases said calling time, said call management node disconnecting said first network terminal from said account management node, when the call-credit of said pre-paid account is positive, thereby allowing said first network terminal to resume said call.

2. The network architecture according to claim 1, wherein said account management node monitors said call-credit during said call, and
wherein said account management node sends an indication to said call management node, that said call-credit is approaching zero, when said account management node detects that said call-credit is approaching zero.

3. The network architecture according to claim 1, wherein said call management node sends a modified message to said first network node, for said first network node to allocate said second circuit,
wherein said call management node sends a command to said account management node, for said account management node to allocate said second circuit, and
wherein said call management node produces said modified message by replacing an originating identification code respective of said first network terminal, with a unique identification code respective of said account management node, and a destination identification code respective of said second network terminal, with said originating identification code.

4. The network architecture according to claim 1, wherein said first network node sends a call waiting message to said first network terminal, following the receipt of said modified message by said first network node, to notify said first network terminal that said account management node is calling said first network terminal, and
wherein said call waiting message comprises:
an audio message;
a graphical message; and
a textual message.

5. The network architecture according to claim 1, wherein said call management node sends a modified message to said first network node, for said first network node to dis-allocate said second circuit,
wherein said call management node sends a command to said account management node, for said account management node to dis-allocate said second circuit, and
wherein said call management node produces said modified message by replacing a destination identification code respective of said second network terminal, with a unique identification code respective of said account management node.

6. The network architecture according to claim 1, wherein said account management node sends an indication to said call management node that said call-credit is positive, when said account management node detects that said call-credit is positive.

7. The network architecture according to claim 1, wherein said call management node includes a data structure for associating signaling destination information respective of said first network node, with signaling destination information respective of said account management node.

8. The network architecture according to claim 7, wherein said data structure includes signaling destination information having at least the fields selected from the list consisting of:
first network node point code;
account management node point code;
first network node resource identification;
first network node circuit identification code;
account management node resource identification;
account management node circuit identification code;
first network terminal mobile identification number;
resource group identification; and
trunk identification.

9. Network architecture for terminating a first call between a first network terminal and a second network terminal over a first circuit, when a call-credit of a pre-paid account of the first network terminal is zero, the network architecture comprising:
a first network node connected to said first network terminal;
a second network node connected to said second network terminal;
an account management node connected to said first network node, said account management node managing a pre-paid account associated with said first network terminal; and
a call management node connected to said first network node via a first signaling link, to said second network node via a second signaling link, and to said account management node via a communication link, said call management node disconnecting said second network terminal from said second network node, by sending a first modified message to said second network node to dis-allocate said first circuit, said call management node establishing a second call between said first network terminal and said account management node, for said account management node to send an explanatory message to said first network terminal for terminating said first call, and said call management node terminating said first call, when said call-credit is zero,
wherein said call management node produces said first modified message by replacing a destination identification code respective of said second network terminal, with a unique identification code respective of said account management node.

10. The network architecture according to claim 9, wherein said account management node monitors said call-credit during said first call, and
wherein said account management node sends an indication to said call management node that said call-credit is zero, when said account management node detects that said call-credit is zero.

11. The network architecture according to claim 9, wherein said call management node establishes said second call, by sending a second modified message to said second network node to re-allocate said first circuit, receiving a first signaling message from said second network node that said second network node has allocated a second circuit associated with said first circuit, and sending a first command to said account management node to allocate said second circuit, and
wherein said call management node produces said second modified message by replacing said destination identification code, with said unique identification code.

12. The network architecture according to claim 11, wherein said call management node terminates said first call and said second call, by sending a third modified message to said second network node to dis-allocate said second circuit, sending a second command to said account management node to dis-allocate said second circuit, receiving a second signaling message from said second network node that said second network node has dis-allocated said first circuit, and sending a fourth modified message to said first network node to dis-allocate said first circuit, and
wherein said call management node produces each of said third modified message and said fourth modified message, by replacing said destination identification code with said unique identification code.

13. The network architecture according to claim 9, wherein said call management node establishes said second call, by sending a second modified message to said second network node to re-allocate said first circuit, receiving a first signaling message from said second network node that said second network node has allocated a second circuit associated with said first circuit, sending a third modified message to said first network node to allocate said second circuit, receiving a second massage from said first network node that said first network node has allocated a third circuit associated with said second circuit, and sending a first command to said account management node to allocate said third circuit, and
wherein said call management node produces each of said second modified message and said third modified message, by replacing said destination identification code with said unique identification code.

14. The network architecture according to claim 13, wherein said call management node terminates said first call and said second call, by sending a fourth modified message to said first network node to dis-allocate said third circuit, sending a second command to said account management node to dis-allocate said third circuit, receiving a third signaling message from said first network node that said first network node has dis-allocated said second circuit, sending a fifth modified message to said second network node to dis-allocate said second circuit, receiving a fourth signaling message from said second network node that said second network node has dis-allocated said first circuit, and sending a sixth modified message to said first network node to dis-allocate said first circuit, and
wherein said call management node produces each of said fourth modified message, said fifth modified message and said sixth modified message, by replacing said destination identification code with said unique identification code.

15. Network architecture for enabling a first network terminal which requests to establish a first call with a second network terminal over a first circuit, to increase a call-credit of a pre-paid account associated with said first network terminal, when said call-credit is approaching zero, the network architecture comprising:
a first network node connected to said first network terminal;
a second network node connected to said second network terminal;
an account management node connected to said first network node, said account management node managing said pre-paid account; and
a call management node connected to said first network node via a first signaling link, to said second network node via a second signaling link, and to said account management node via a communication link, said call management node establishing a second call between said first network terminal and said account management node, for said first network terminal to increase said call-credit, said call management node terminating said second call when said call-credit is positive, and said call management node sending a first modified message to said second network node to allocate said first circuit,
wherein said call management node produces said first modified message by replacing a point code associated with said first network node, with another point code associated with said call management node.

16. The network architecture according to claim 15, wherein said call management node detects that said first network terminal is a pre-paid terminal, according to an originating identification code associated with said first network terminal,
wherein said call management node sends a first command to said account management node to check said call-credit,
wherein said account management node detects that said call-credit is approaching zero, and
wherein said account management node sends a second command to said call management node that said call-credit is approaching zero.

17. The network architecture according to claim 15, wherein said call management node establishes said second call, by sending a second modified message to said second network node to allocate said first circuit, receiving a first signaling message from said second network node that said second network node has allocated a second circuit associated with said first circuit, and sending a first command to said account management node to allocate said second circuit,
wherein said call management node terminates said second call, by sending a third modified message to said second network node to dis-allocate said second circuit, sending a second command to said account management node to dis-allocate said second circuit, receiving a second signaling message from said second network node that said second network node has dis-allocated said first circuit, and sending a fourth modified message to said first network node to dis-allocate said first circuit, and
wherein said call management node produces each of said second modified message, said third modified message and said fourth modified message, by replacing said destination identification code with said unique identification code.

18. The network architecture according to claim 15, wherein said call management node establishes said second call, by sending a second modified message to said second network node to allocate said first circuit, receiving a first signaling message from said second network node that said second network node has allocated a second circuit associated with said first circuit, sending a third modified message to said first network node to allocate said second circuit, receiving a second massage from said first network node that said first network node has allocated a third circuit associated with said second circuit, and sending a first command to said account management node to allocate said third circuit,
wherein said call management node terminates said second call, by sending a fourth modified message to said first network node to dis-allocate said third circuit, sending a second command to said account management node to dis-allocate said third circuit, receiving a third signaling message from said first network node that said first network node has dis-allocated said second circuit, sending a fifth modified message to said second network node to dis-allocate said second circuit, receiving a fourth signaling message from said second network node that said second network node has dis-allocated said first circuit, and sending a sixth modified message to said first network node to dis-allocate said first circuit, and
wherein said call management node produces each of said second modified message, said third modified message, said fourth modified message, said fifth modified message and said sixth modified message, by replacing said destination identification code with said unique identification code.

19. Method for enabling a first network terminal connected in a call with a second network terminal via a first circuit, to purchase calling time during the call, the method comprising the procedures of:
sending a first modified message to a network node associated with said first network terminal, for said network node to allocate a second circuit, for connecting said first network terminal with an account management node over said second circuit, whereby said network node notifies said first network terminal of a waiting call from said account management node;
receiving a signaling message from said network node that said first network terminal has accepted said waiting call;
sending a command to said account management node to initiate a pre-call procedure together with said first network terminal, over said second circuit, while said call at said network node over said first circuit, is on hold;
receiving a second indication from said account management node that said pre-call procedure is complete; and
sending a second modified message to said network node, for said network node to dis-allocate said second circuit, thereby enabling said first network terminal to resume said call with said second network terminal, over said first circuit.

20. The method according to claim 19, further comprising a preliminary procedure of receiving an indication from said account management node, that a call-credit of said first network terminal in said call, is approaching zero.

21. The method according to claim 20, further comprising a preliminary procedure of checking said call-credit.

22. The method according to claim 19, wherein each of said first modified message and said second modified message is produced, by replacing a destination identification code respective of said second network terminal, with a unique identification code respective of said account management node.

23. The method according to claim 19, wherein each of said first modified message and said second modified message is sent over a signaling link.

24. The method according to claim 19, wherein said command is sent over a communication link.

25. The method according to claim 19, wherein each of said first circuit and said second circuit is a circuit for transmitting voice.

26. Method for terminating a call between a first network terminal and a second network terminal over a first circuit, when a call-credit of a pre-paid account of the first network terminal is zero, the method comprising the procedures of:
sending a first modified message to a second network node associated with said second network terminal, to dis-allocate said first circuit, thereby disconnecting said second network terminal from said second network node;
sending a second modified message to said second network node, to re-allocate said first circuit for further directing said call to an account management node, for connecting said first network terminal with said account management node;
sending a first command to said account management node to allocate a second circuit which is selected by said second network node, thereby connecting said first network terminal with said account management node over said first circuit and said second circuit;
sending a third modified message to said first network node, to allocate a third circuit which is selected by said second network node, thereby connecting said first network node with said second network node over said first circuit and said third circuit;
sending a second command to said account management node to allocate a fourth circuit which is selected by said first network node, thereby connecting said first network terminal with said account management node, over said first circuit, said third circuit, and said fourth circuit;
sending an explanatory message to said first network terminal for terminating said call; and
terminating said call.

27. The method according to claim 26, further comprising a preliminary procedure of receiving an indication from said account management node, that said call-credit is zero.

28. The method according to claim 27, further comprising a preliminary procedure of checking said call-credit.

29. The method according to claim 26, further comprising a procedure of receiving a signaling message from said second network node, after performing said procedure of sending said first modified message, that said second network node has dis-allocated said first circuit.

30. The method according to claim 26, further comprising a procedure of receiving a signaling message from said second network node, after performing said procedure of sending said second modified message, that said second network node has allocated said second circuit associated with said first circuit.

31. The method according to claim 26, further comprising a procedure of receiving a signaling message from said first network node, after performing said procedure of sending said third modified message, that said first network node has allocated said fourth circuit associated with said third circuit.

32. The method according to claim 26, wherein each of said first modified message, said second modified message, and said third modified message is sent over a signaling link.

33. The method according to claim 26, wherein said explanatory message is sent over a voice link.

34. The method according to claim 26, wherein said explanatory message is selected from the list consisting of:
an audio message;
a graphical message; and
a textual message.

35. The method according to claim 26, wherein each of said first command and said second command is sent over a communication link.

36. The method according to claim 26, wherein each of said first modified message, said second modified message, and said third modified message is produced by replacing a destination identification code associated with said second network terminal, with a unique identification code associated with said account management node.

37. The method according to claim 26, wherein each of said first circuit, said second circuit, said third circuit, and said fourth circuit is a circuit for transmitting voice.

38. Method for enabling a first network terminal which requests to establish a call with a second network terminal over a first circuit, to increase a call-credit of a pre-paid account associated with said first network terminal, when said call-credit is approaching zero, the method comprising the procedures of:
sending a first modified message to a second network node associated with said second network terminal, to allocate said first circuit for further directing said call to an account management node, for connecting said first network terminal with said account management node;
sending a second modified message to said first network node to allocate a second circuit, following allocation of said second circuit by said second network node;
sending a first command to said account management node to allocate a third circuit, following allocation of said third circuit by said first network node, thereby connecting said first network terminal with said account management node;
sending a second command to said account management node to allocate a fourth circuit which is selected by said second network node, thereby connecting said first network terminal with said account management node;
receiving a second indication from said account management node, that said call-credit is positive;
sending a third modified message to said first network node, to dis-allocate said third circuit;
sending a fourth modified message to said second network node, to dis-allocate said second circuit;
sending a fifth modified message to said second network node, to dis-allocate said fourth circuit; and
sending a first signaling message to said second network node, to re-allocate said first circuit, following dis-allocation of said first circuit by said second network node, thereby connecting said first network terminal with said second network terminal.

39. The method according to claim 38, further comprising a preliminary procedure of receiving an indication from said account management node, that said call-credit is insufficient for establishing said call.

40. The method according to claim 39, further comprising a preliminary procedure of checking said call-credit.

41. The method according to claim 40, further comprising a preliminary procedure of receiving a second signaling message from said first network node, that said first network terminal requests to establish said call.

42. The method according to claim 38, further comprising a procedure of receiving a second signaling message from said second network node after performing said procedure of—sending said first modified message, that said second network node has allocated said second circuit.

43. The method according to claim 38, further comprising a procedure of receiving a second signaling message from said first network node after performing said procedure of sending said second modified message, that said first network node has allocated said third circuit.

44. The method according to claim 38, wherein each of said first modified message, said second modified message, said third modified message, said fourth modified message, said fifth modified message and said first signaling message is sent over a signaling link.

45. The method according to claim 38, wherein each of said first command, said second command and said second indication is sent over a communication link.

46. The method according to claim 38, wherein each of said first modified message, said second modified message, said third modified message, said fourth modified message, and said fifth modified message, is produced by replacing a destination identification code associated with said second network terminal, with a unique identification code associated with said account management node.

47. The method according to claim 38, wherein each of said first circuit, said second circuit, said third circuit, and said fourth circuit is a circuit for transmitting voice.
